(19) United States
(12) Patent Application Publication
(10) Pub. No.: US 2002/0071491 A1
(43) Pub. Date: Jun. 13, 2002

(54) Signal processor

(76) Inventors: Akira Sugiyama, Kanagawa (JP); Haruo Togashi, Kanagawa (JP); Shin Todo, Kanagawa (JP); Hideyuki Matsumoto, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/002,661

(22) Filed: Oct. 31, 2001

(30) Foreign Application Priority Data
Nov. 1, 2000 (JP) 2000-335069

(51) Int. Cl. H04B 1/66

(52) U.S. Cl. 375/240.23

(57) ABSTRACT

A signal processor provides stable processing, for each frame, of variable-length coded data. An MPEG stream is input in the SDTI format, and a data active length for each frame is determined based on header information for each SDTI frame to generate a “Frame End” signal which is synchronized with the end-of-frame data. The “Frame End” signal is input to a set terminal of an RS flip-flop circuit via a delay circuit. On the other hand, a start code at the beginning of a frame is detected by a detector circuit and an OR circuit, and the result of detection is input to a reset terminal of the RS flip-flop circuit. A switching control is performed so that an enable signal indicates invalid data when the frame end pulse is detected and the enable signal indicates valid data when the start code is detected in response to the output of the RS flip-flop circuit. The data is invalid in a period from the end of a frame until the next start code has been detected, and thereby reducing the processing delay while providing a stable operation for irregular stream inputs.

### BACKGROUND OF THE INVENTION

1. Field of the Invention

The present invention relates to a signal processor capable of providing stable processing, for each frame, of video data compressed by variable-length coding.

2. Description of the Related Art

In recent years, so-called MPEG (Moving Picture Experts Group) encoding has been widely used as a compression algorithm for digital video signals. MPEG is a motion picture compression standard using the DCT (Discrete Cosine Transform) and predictive coding. MPEG encoding involves: breaking picture data of one frame into macroblocks having a predetermined size, each macroblock being predictive coded using a motion vector; and further breaking each macroblock into DCT blocks, each DCT block being subjected to the DCT for variable-length coding. MPEG-2 which was developed to provide higher extensibility and higher picture quality is the dominant standard in the state of the art.

Generally, MPEG-2 data is formed of a data stream having a hierarchical structure. The hierarchical structure is composed of a sequence layer, a GOP (Group Of Pictures) layer, a picture layer, a slice layer, and a macroblock layer in the stated order from the top, each layer containing one or more sublayers. Each layer contains a header section. The layers except for the macroblock layer have start codes arranged before the header sections.

The macroblock is a block having 16×16 pixels, and one or more macroblocks form one slice. It is required that a slice header always reside at the left end of the screen. The slice start code contains vertical position information of the slice in question, and the slice header stores information such as extended slice vertical position information or quantizer scale information. One picture corresponds to one screen, and a slice is not permitted to extend over pictures.

MPEG-2 encoding starts signal processing by detecting the start code which is unique to each layer. For example, a frame is identified based on three start codes consisting of the start code of the sequence layer, called a sequence header, a group start code indicating the beginning of a GOP, and a picture start code. Therefore, only when the start code at the beginning of the next frame data is detected, it is seen that the previous frame data has been completed, so that the processing of the current frame can be terminated.

FIG. 30 is a timing chart which illustrates the state-of-the-art frame processing mentioned above. First of all, start codes indicating the beginning of frames are defined as consisting of a sequence header code (sequence_header_code:32′h 00 00 01 B3) complying with the MPEG standard, a group start code (group_start_code:32′h 00 00 01 B8), a picture start code (picture_start_code:32′h 00 00 01 00), and a system start code (system_start_code) appended to each frame.

Referring to FIG. 30, waveform (a) represents a frame signal indicating a frame in an SDTI (Serial Data Transfer Interface) that is a transfer format in which a digital video signals etc. are transferred. The frame signal has pulses inverted every ½ frame. Waveform (b) represents an MPEG data stream having start codes at the beginning of frames, followed by data. If the data volume is insufficient for one frame period defined by the frame signal, invalid data is inserted between the end of the data and the beginning of the next frame.

Still referring to FIG. 30, waveform (c) represents an enable signal indicating a valid period of the data. In a period when the invalid data exists, the enable signal is at a low level. Although omitted in waveform (c) for simplicity, in practice, the enable signal goes high and low in shorter periods. Therefore, it is difficult to determine the end of data in a frame only with the trailing edges of the enable signal. As described previously, the beginning of frames is determined only by using the start codes arranged at the head of the data.

According to this conventional method, only when a start code indicating the beginning of the next frame has been detected, it is seen that the current frame has been completed. A problem with the conventional method is that the current frame is still processed in an invalid data period, greatly delaying the processing.

As in the fifth frame in waveform (b) by way of example, a start code at the beginning of a frame may be undetectable due to bit inversion etc., for example, if there is a failure in a transmission path. Such an inconvenience does not restrictively result from this, and other causes may also be contemplated. If a failure in a transmission path etc. cause incorrect streams to be input, a desired start code may not arrive at a desired time. Otherwise, a start code may occur with a pseudo timing other than the inherent timing.

As indicated by a dotted line in waveform (b) of FIG. 30, since the beginning of the fifth frame is not detected, it cannot be recognized that the previous fourth frame has completed, and the fourth frame is still processed. The fourth frame is processed until a start code indicating the beginning of the next frame has been detected. A problem occurs in that, since the start code is missed, the valid data originally subsequent thereto may be identified as invalid data.

In addition, the system is caused to continue processing the thus generated valid data, leading to problems such as more time being required to return to a correct stream, and failed returning causing hang-up of the system. The only method of dealing with the failure to return to the correct stream is to initialize the system.

VTRs (video tape recorders) in broadcasting services are designed so that a register is reset every frame in order to provide stable processing for each frame by avoiding undesired circumstances such as the failure to return or by minimizing the time required to return. This ensures that initialization is performed for each frame.

However, this conventional technique encounters a problem in that, since the same start code is used to determine both the end of one frame and the beginning of the next frame at the same time, it is very difficult in view of timing to reset the processing every frame.

### SUMMARY OF THE INVENTION

Accordingly, it is an object of the present invention to provide a signal processor capable of processing data, which stores a variable length code for each frame, with a high stability for each frame.

To this end, in one aspect of the present invention, a signal processor for processing a predetermined unit of input data containing a variable length code and information providing the active length of the variable length code is disclosed. The signal processor includes an input unit for inputting the input data, a start detecting unit for detecting the start of the predetermined unit of the input data, and an end detecting unit for detecting the end of the predetermined unit of the input data input by the input unit based on the information providing the active length. The signal processor further includes a signal processing unit for making an action on the variable length code active at the start detected by the start detecting unit, for making the action on the variable length code inactive at the end detected by the end detecting unit, and for initializing the state of the action on the variable length code at the end detected by the end detecting unit.

Preferably, the input data is MPEG encoded data.

The signal processor may further include a recording unit for recording the output of the signal processing unit.

In another aspect of the present invention, a signal processing method for processing a predetermined unit of input data containing a variable length code and information providing the active length of the variable length code is disclosed. The signal processing method includes the steps of inputting the input data, detecting the start of the predetermined unit of the input data input in the inputting step, and detecting the end of the predetermined unit of the input data input in the inputting step based on the information providing the active length. The signal processing methods further includes the step of making an action on the variable length code active at the start detected in the start detecting step, making the action on the variable length code inactive at the end detected in the end detecting step, and initializing the state of the action on the variable length code at the end detected in the end detecting step.

### BRIEF DESCRIPTION OF THE DRAWINGS

FIG. 1 is a schematic view of the hierarchical structure of MPEG-2 data;

FIG. 2 is a simplified table showing the content and bit allocation of data contained in the MPEG-2 stream;

FIG. 3 is a simplified table showing the content and bit allocation of data contained in the MPEG-2 stream;

FIG. 4 is a simplified table showing the content and bit allocation of data contained in the MPEG-2 stream;

FIG. 5 is a simplified table showing the content and bit allocation of data contained in the MPEG-2 stream;

FIG. 6 is a simplified table showing the content and bit allocation of data contained in the MPEG-2 stream;

FIG. 7 is a simplified table showing the content and bit allocation of data contained in the MPEG-2 stream;

FIG. 8 is a simplified table showing the content and bit allocation of data contained in the MPEG-2 stream;

FIG. 9 is a simplified table showing the content and bit allocation of data contained in the MPEG-2 stream;

FIG. 10 is a simplified table showing the content and bit allocation of data contained in the MPEG-2 stream;

FIG. 11 is a simplified table showing the content and bit allocation of data contained in the MPEG-2 stream;

FIG. 12 is a simplified table showing the content and bit allocation of data contained in the MPEG-2 stream;

FIGS. 13A and 13B are views of an array of data in bytes;

FIG. 14 is a schematic view of headers in an MPEG stream in one embodiment of the present invention;

FIG. 15 is a block diagram of the structure of an example recorder/player in one embodiment of the present invention;

FIG. 16 is a schematic view of a track format formed on a magnetic tape;

FIGS. 17A and 17B are schematic views of a chroma format;

FIGS. 18A and 18B are schematic views of another chroma format;

FIGS. 19A and 19B are schematic views of another chroma format;

FIGS. 20A and 20B are schematic views which illustrate the output scheme of a video encoder, and variable length coding;

FIGS. 21A and 21B are schematic views which illustrate reorganization of the output data from the video encoder;

FIGS. 22A and 22B are schematic views which illustrate a process to pack reorganized data into a sync block;

FIGS. 23A and 23B are schematic views which illustrate the advantages of reorganization of coefficients and the packing process;

FIGS. 24A and 24B are schematic views which illustrate the advantages of reorganization of coefficients and the packing process;

FIG. 25 is a block diagram specifically showing the structure of an ECC encoder;

FIG. 26 is a schematic view of an example address configuration in a main memory;

FIG. 27 is a schematic view of the data structure of an example item stored in an SDTI block;

FIG. 28 is a block diagram of the construction of an example recording MFC;

FIG. 29 is a timing chart which illustrates frame processing according to one embodiment of the present invention; and

FIG. 30 is a timing chart which illustrates frame processing in the state of the art.

### DESCRIPTION OF THE PREFERRED EMBODIMENTS

In the following description, a digital VTR is implemented as one embodiment of the present invention. The digital VTR is suitable for use in a broadcasting environment.

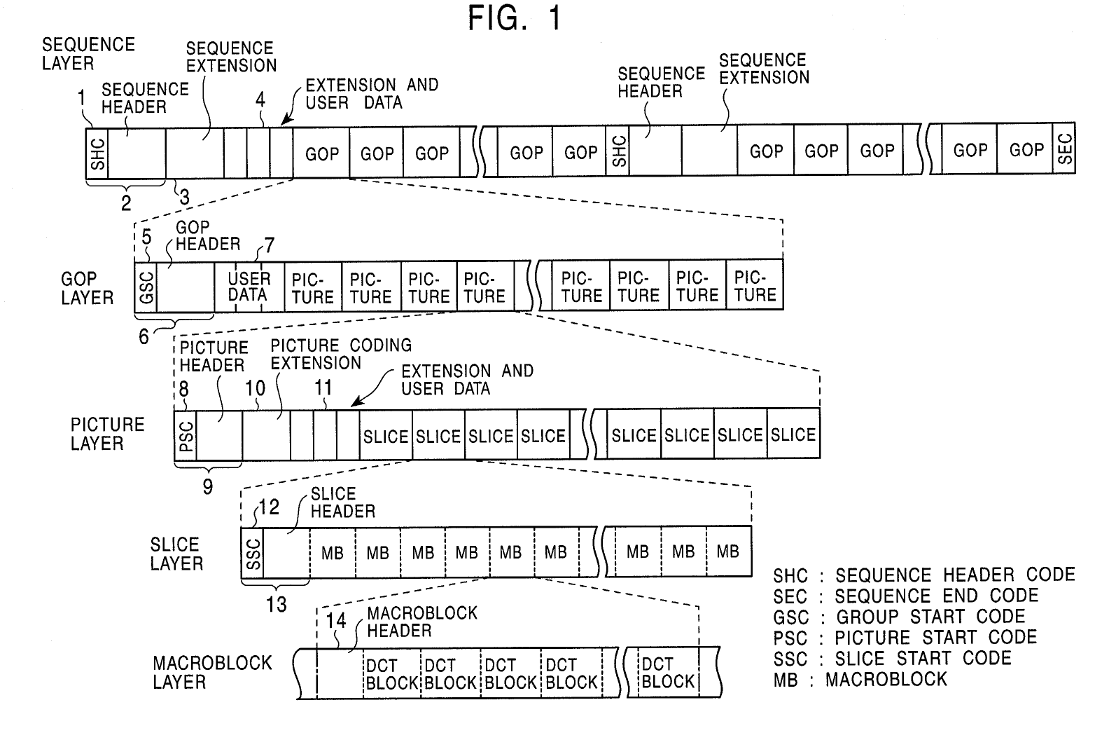

This embodiment employs MPEG-2 as a compression algorithm, by way of example. MPEG-2 is a combination of motion-compensated predictive coding and DCT-based compression. The MPEG-2 data structure is hierarchical. FIG. 1 schematically illustrates the hierarchical structure of a typical MPEG-2 data stream. The data structure is composed of a macroblock layer, a slice layer, a picture layer, a GOP layer, and a sequence layer, in the stated order from lower layers.

As shown in FIG. 1, the macroblock layer includes DCT blocks which are units of the DCT. The macroblock layer is composed of a macroblock header and a plurality of DCT blocks. The slice layer is formed of a slice header section and one or more macroblocks. The picture layer is formed of a picture header section and one or more slices. The picture corresponds to one screen. The GOP layer is formed of a GOP header section, intra-frame coded pictures or I-pictures, and predictive-coded pictures or P- and B-pictures.

I-pictures (intra-coded pictures) are coded using information only within the current picture. I pictures can be thus decoded using only their own information.

P-pictures (predictive-coded pictures) use the temporally earlier I- or P-pictures, which have been decoded, as a prediction picture or a differential reference picture. For each macroblock in a P-picture, a difference between the prediction picture after motion compensation and that P-picture may be encoded, or that P-picture itself may be encoded. More efficient approach is selected.

B-pictures (bi-directionally predictive-coded pictures) use three kinds of prediction pictures which are differential reference pictures, consisting of the temporally earlier I- or P-pictures, which have been decoded, the temporally later I- or P-pictures, which have been decoded, and interpolation pictures created from both. For each macroblock in a B-picture, a difference between that B-picture and either of the three kinds of predictive coding after motion compensation may be encoded, or each macroblock in a B-picture may intra-coded. The most efficient approach is selected.

Accordingly, the macroblock types include an intra-frame coded macroblock, a forward inter-frame predictive macroblock in which future frames are predicted from previous frames, a backward inter-frame predictive macroblock in which previous frames are predicted from future frames, and a bi-directional macroblock in which frames are forward and backward predicted. All of the macroblocks contained in an I-picture are intra-frame coded macroblocks. A P-picture contains intra-frame coded macroblocks and forward inter-frame predictive macroblocks. A B-picture contains the above-noted four types of macroblocks.

The GOP layer includes at least one I-picture, and may not include a P- or B-picture. The uppermost sequence layer includes a sequence header section and a plurality of GOPs, as shown in FIG. 1.

In the MPEG format, a slice is one variable length code sequence. The term “variable length code sequence” is a sequence in which the data boundary cannot be detected until variable length codes have been precisely decoded.

A start code having a predetermined bit pattern organized in bytes resides at the beginning of each of the sequence layer, the GOP layer, the picture layer, and the slice layer. The start code at the beginning of the sequence layer is called a sequence header code, and the start codes at the beginning of the other layers are called a GOP start code, a picture start code, and a slice start code, respectively. The predetermined bit pattern may be represented by [00 00 01 xx] (hereinafter bracketed expressions [ ] are in hexadecimal form), in which two digits are grouped and [xx] indicates variable values depending upon the layers.

The start codes and the sequence header code each have four-byte (=32-bit) data, in which the fourth byte value helps to identify the type of information subsequent thereto. Since the start codes and the sequence header code are organized in bytes, pattern matching for four-byte data is only required for acquisition.

The upper four bits of data in the one byte of data subsequent to the start codes corresponds to an identifier for the content of extension data regions as described later. The value of the identifier helps to identify the content of the extension data.

It is noted that the macroblock layer and DCT blocks in a macroblock do not include such an identification code having a bit pattern organized in bytes.

The header sections of the respective layers will be described in more detail.

The sequence layer includes, first, a sequence header 2, followed by a sequence extension 3 and extension and user data 4. A sequence header code 1 resides before the sequence header 2. Although not shown in FIG. 1, each of the sequence extension 3 and the extension and user data 4 also includes a start code at the beginning. The header section of the sequence layer is constituted by the sequence header 2, the sequence extension 3, and the extension and user data 4.

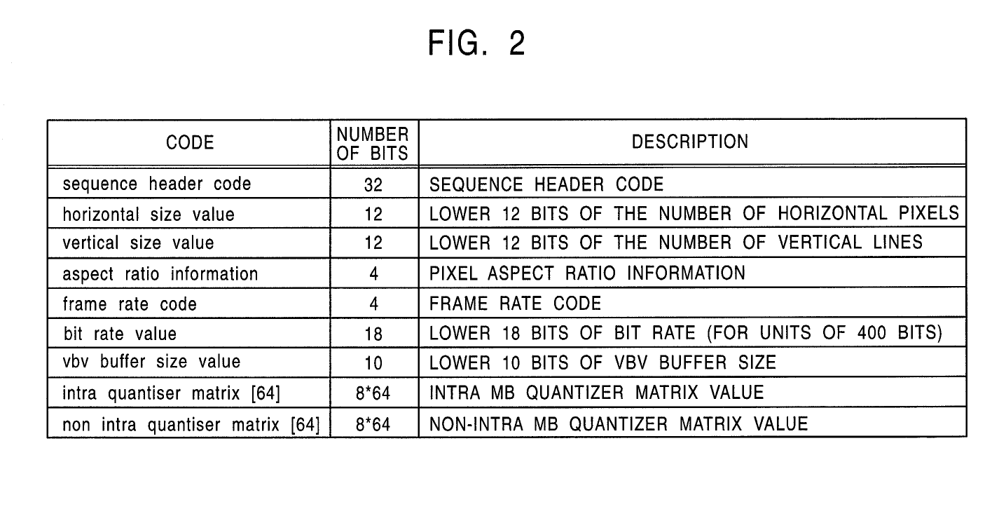

As shown in FIG. 2 which shows descriptions and allocation bits, the sequence header 2 contains information set for a unit of sequence, to each of which a predetermined number of bits is allocated. The stored information includes the sequence header code 1, a coded picture size consisting of the number of horizontal pixels and the number of vertical lines, an aspect ratio, a frame rate, a bit rate, a VBV (Video Buffering Verifier) buffer size, and a quantizer matrix.

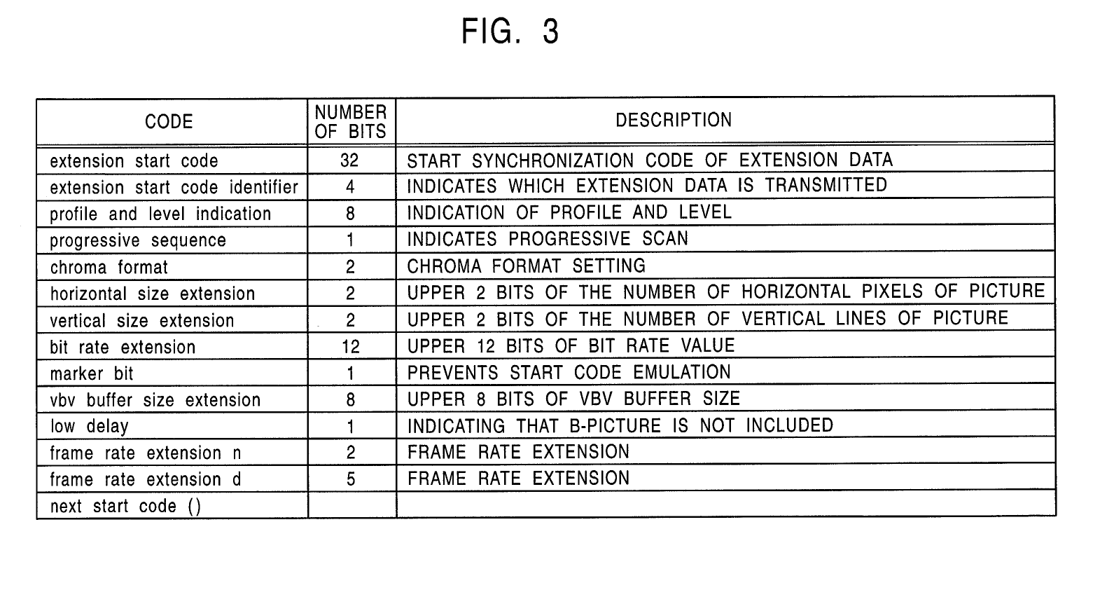

In the sequence extension 3 which follows the extension start code subsequent to the sequence header 2, as shown in FIG. 3, additional data for use in MPEG-2 including a profile, a level, a chroma (chrominance) format, and a progressive sequence is set.

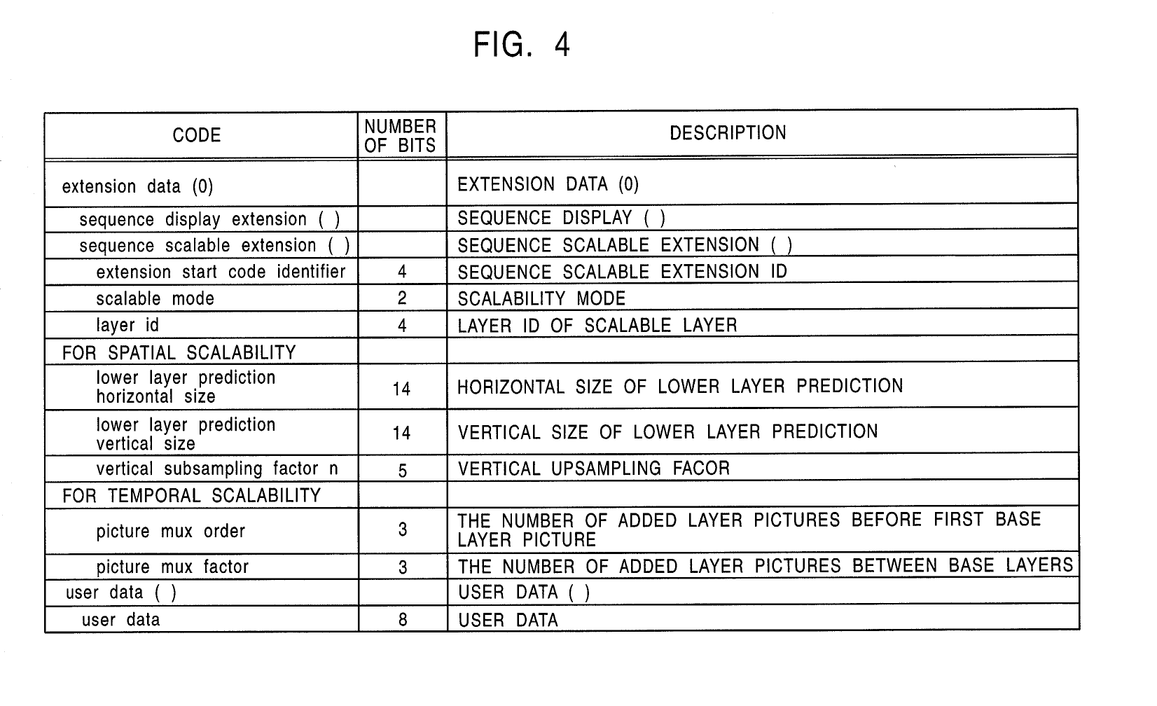

As shown in FIG. 4, the extension and user data 4 may contain information such as the RGB conversion characteristics of the original signal and the size of a displayed picture, as expressed by sequence display ( ), and may contain setting of scalability mode and scalable layer, as expressed by sequence scalable extension ( ).

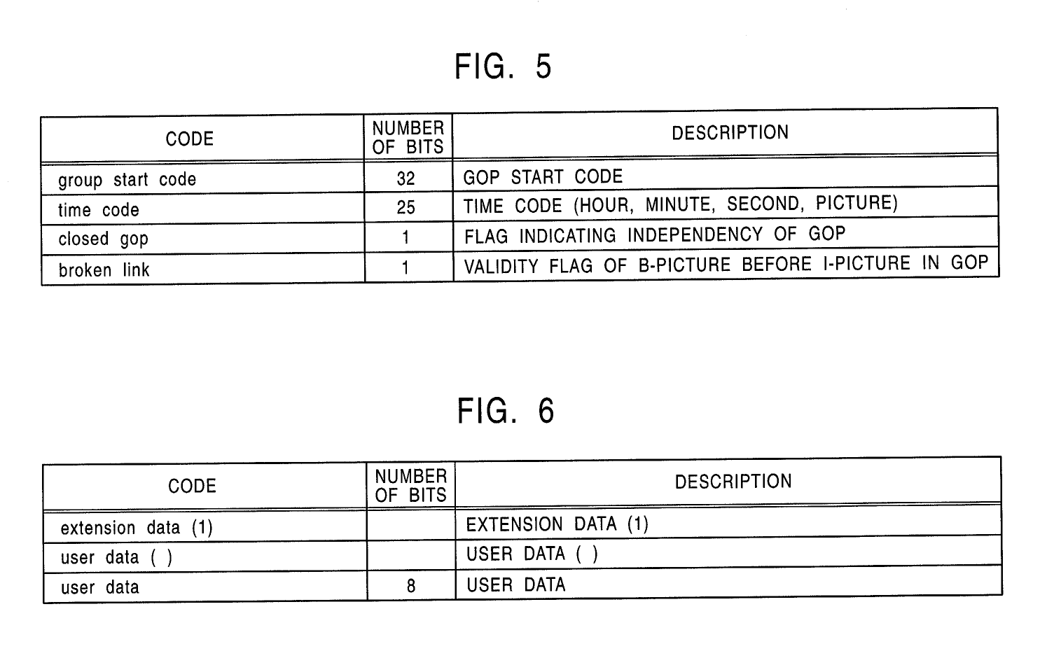

The header section of the sequence layer is followed by GOPS. As shown in FIG. 1, a GOP header 6 and user data 7 are at the top of a GOP. The GOP header 6 and the user data 7 constitute the header section of a GOP. As shown in FIG. 5, the GOP header 6 contains a GOP start code 5, a time code, and flags indicating the independency and validity of that GOP, to which predetermined bits are respectively allocated. As shown in FIG. 6, the user data 7 contains extension data and user data. Although not shown herein, the extension data and the user data each include a start code at beginning thereof.

The header section of the GOP layer is followed by pictures. As shown in FIG. 1, a picture header 9, a picture coding extension 10, and extension and user data 11 are organized at the beginning of a picture. A picture start code 8 resides at the beginning of the picture header 9. The picture coding extension 10 and the extension and user data 11 each contain a start code at the beginning thereof. The picture header 9, the picture coding extension 10, and the extension and user data 11 constitute the header section of the picture layer.

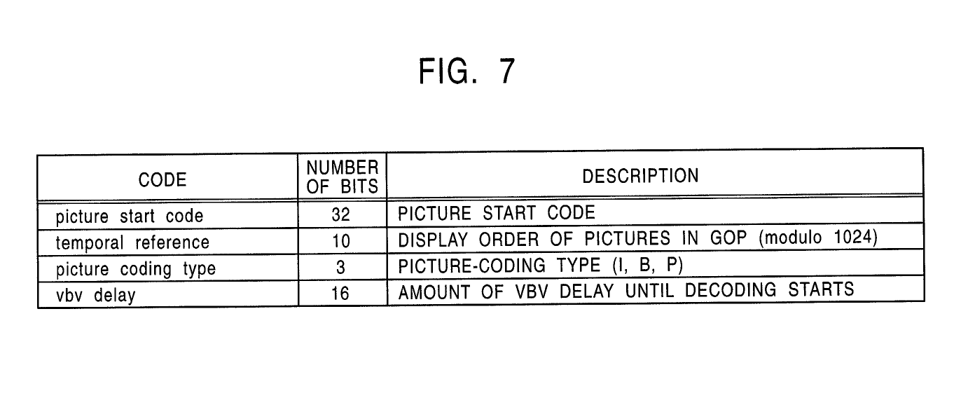

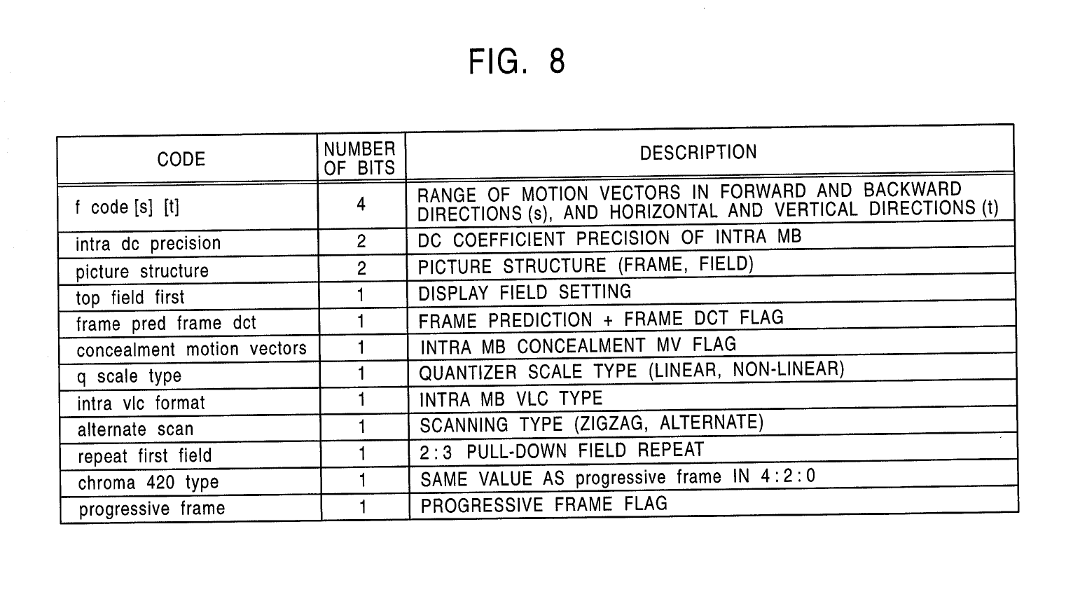

As shown in FIG. 7, the picture header 9 contains the picture code 8, and coding conditions for the screen are set therein. In the picture coding extension 10, as shown in FIG. 8, a range of motion vectors in forward/backward and horizontal/vertical directions is designated, or the picture structure is set. Furthermore, in the picture coding extension 10, the DC coefficient precision of intra macroblocks is set, a VLC type is selected, a linear or nonlinear quantizer scale is selected, a scanning method in the DCT is selected, etc.

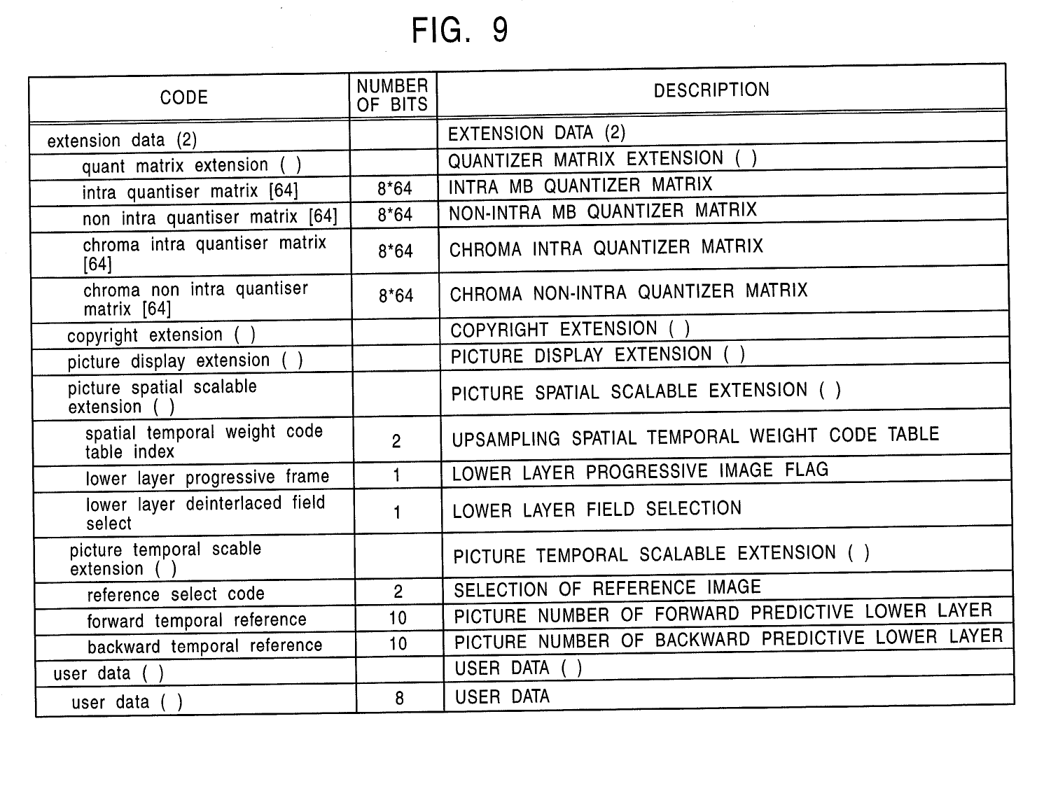

In the extension and user data 11, as shown in FIG. 9, a quantizer matrix is set, spatial scalable parameters are set, etc. These may be set for each picture, resulting in coding according to characteristics of each screen. In the extension and user data 11, copyright information may also be set.

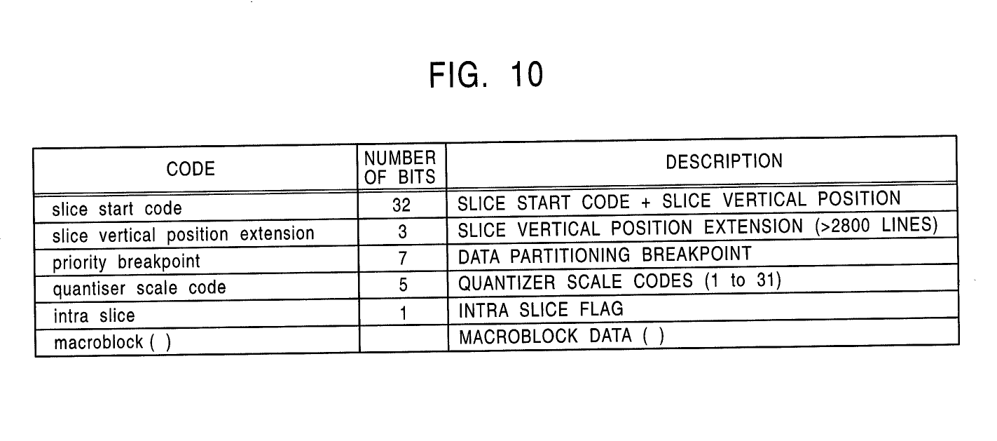

The header section of the picture layer is followed by slices. As shown in FIG. 1, a slice header 13 at the beginning of a slice, and a slice start code 12 resides at the beginning of the slice header 13. As shown in FIG. 10, the slice start code 12 contains vertical position information of that slice. The slice header 13 contains extended vertical position information of that slice, and quantizer scale information.

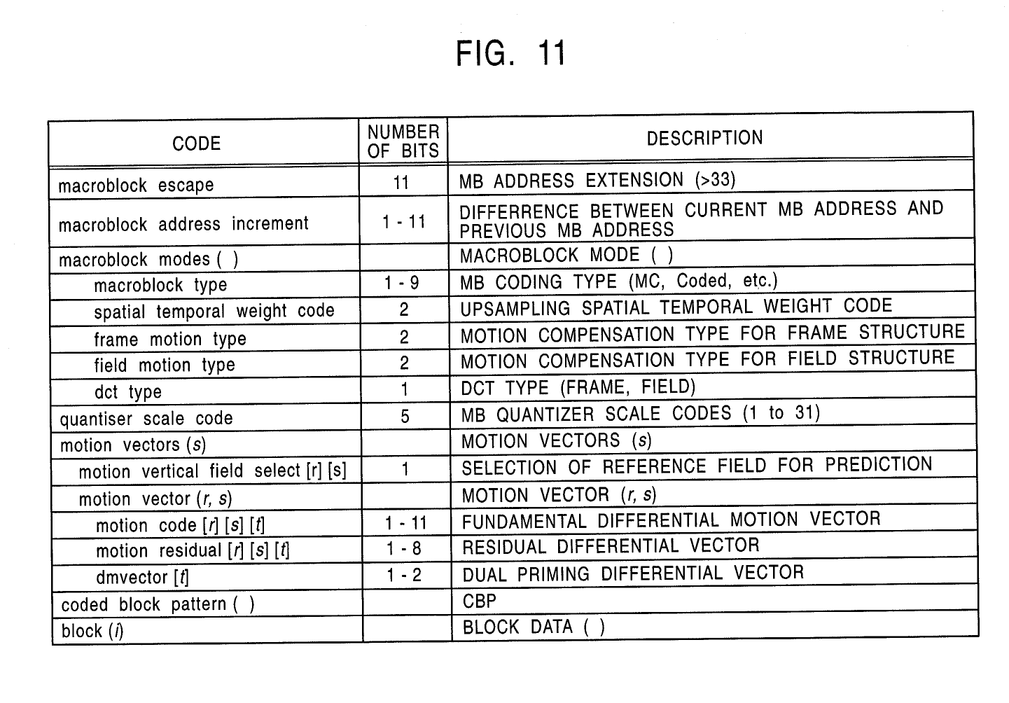

The header section of the slice layer is followed by macroblocks. A macroblock includes a macroblock header 14, followed by a plurality of DCT blocks. As described above, the macroblock header 14 does not include a start code. As shown in FIG. 11, the macroblock header 14 contains relative position information of that macroblock, and motion compensation mode setting, detailed setting of DCT coding, etc. are directed therein.

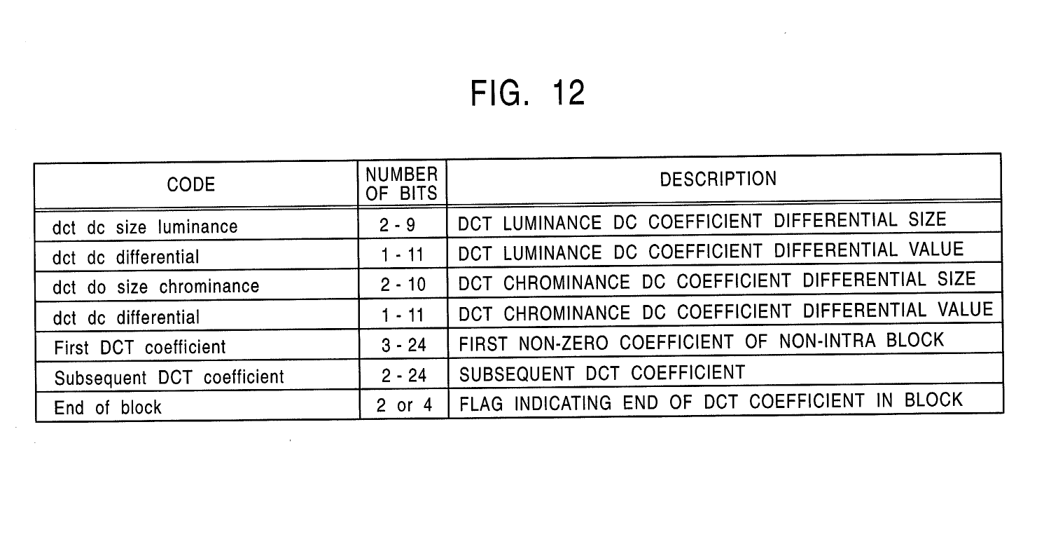

The macroblock header 14 is followed by DCT blocks. As shown in FIG. 12, a DCT block contains variable-length coded DCT coefficients, and data on the DCT coefficients.

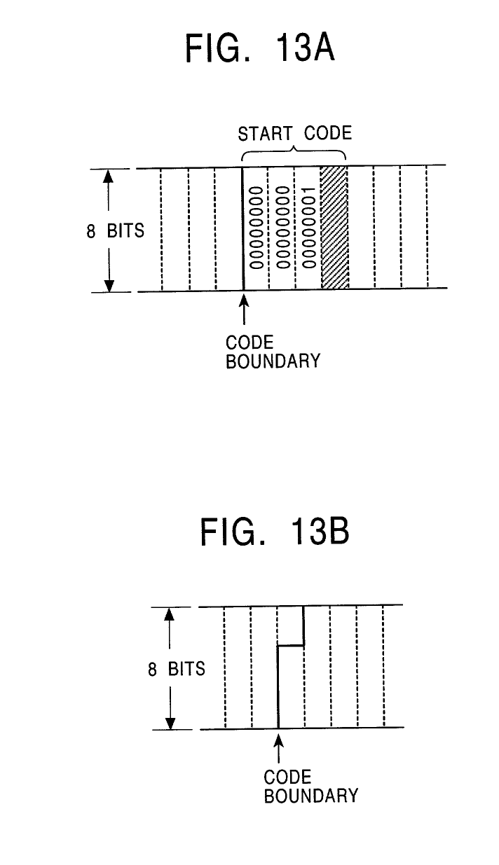

In the layers shown in FIG. 1, the data segmented by solid lines indicate that they are organized in bytes, while the data segmented by dotted lines indicate that they are not organized in bytes. That is, in each of the sequence layer, the GOP layer, and the picture layer, the codes are segmented in bytes, as in an example shown in FIG. 13A. In the slice layer, only the slice start code 12 is segmented in bytes, while the macroblocks can be segmented into bits, as in an example shown in FIG. 13B. In the macroblock layer, the DCT blocks can be segmented in bits.

In order to avoid deterioration of signals due to decoding or encoding, desirably, the coded data is edited without being modified. The P- and B-pictures must be decoded using the temporally previous picture, and the temporally previous and next pictures, respectively, and cannot be thus edited for each frame. In view of this point, in this embodiment, one GOP is composed of a single I-picture.

Since MPEG-2 employs variable length coding, the quantity of data generated in one frame is controlled so that the data generated in one frame can be recorded in a recording area having a predetermined size. Furthermore, in this embodiment, for adaptation to recording on magnetic tapes, one slice is composed of a single macroblock, and the single macroblock is put into a fixed frame having a fixed length.

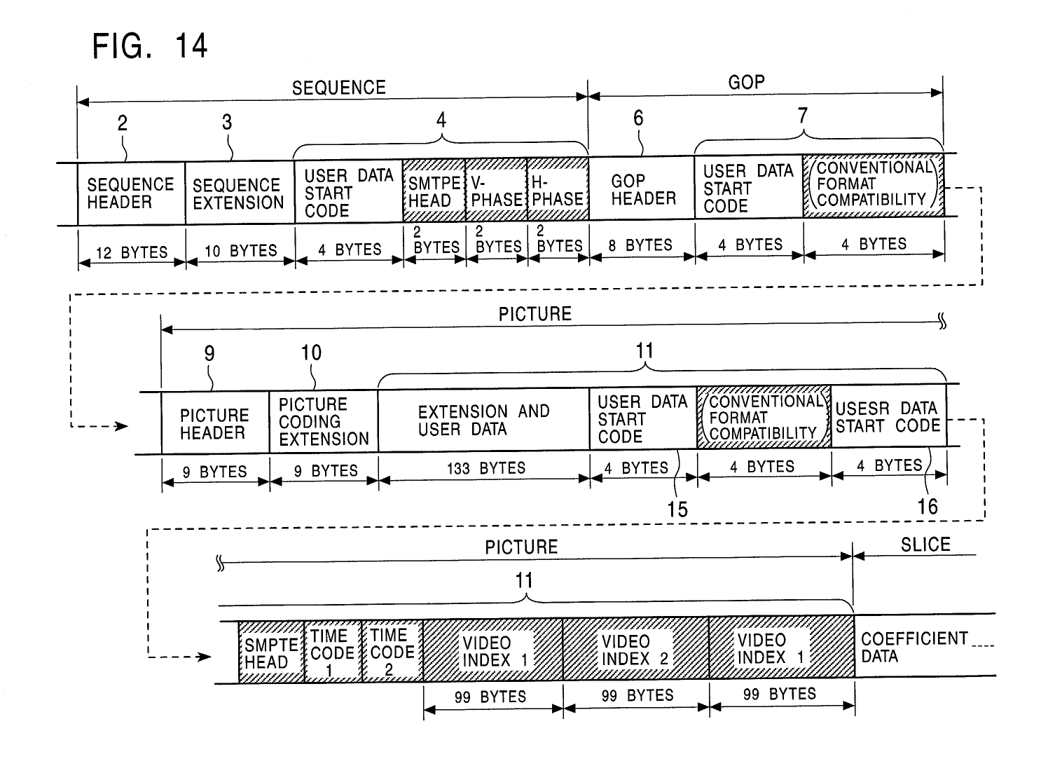

FIG. 14 specifically shows headers of an MPEG stream according to this embodiment. As is obvious from FIG. 1, the header sections of the sequence layer, the GOP layer, the picture layer, the slice layer, and the macroblock layer successively appear from the beginning of the sequence layer. FIG. 14 shows an example successive data stream starting from the sequence header section.

The sequence header 2 having a length of 12 bytes resides at the beginning of the stream, followed by the sequence extension 3 having a length of 10 bytes. The sequence extension 3 is followed by the extension and user data 4. The user data start code of four bytes resides at the beginning of the extension and user data 4, and a user data area subsequent thereto contains information which comforts to the SMPTE (Society of Motion Picture and Television Engineers) standard.

The header section of the sequence layer is followed by the header section of the GOP layer, in which the GOP header 6 having a length of eight bytes is followed by the extension and user data 7. The user data start code of four bytes resides at the beginning of the extension and user data 7, and a user data area subsequent thereto contains information for providing compatibility with other existing video formats.

The header section of the GOP layer is followed by the header section of the picture layer, in which the picture header 9 having a length of nine bytes is followed by the picture coding extension 10 having a length of nine bytes. The extension and user data 11 resides after the picture coding extension 10. The extension and user data is stored so as to extend over 133 bytes from the beginning of the extension and user data 11, followed by the user data start code 15 having a length of four bytes. Subsequent to the user data start code 15, information for providing compatibility with other existing vide formats is stored. The user data start code 16 resides thereafter, and data complying with the SMPTE standard is stored after the user data start code 16. The header section of the picture layer is followed by slices.

A further description is given of macroblocks. A macroblock contained in the slice layer is a set of DCT blocks, and the coding of the DCT blocks involves variable length coding of a sequence of quantized DCT coefficients using a series (run) of zero coefficients followed by a non-zero sequence (level) as one unit. No identification code organized in bytes is added to the macroblock and the DCT blocks in the macroblock.

The macroblock corresponds to a piece divided from a screen (picture) in a matrix of 16 pixels by 16 lines. For example, a slice may be a horizontal sequence of the macroblocks. In a series of slices, the last macroblock of one slice is continuous with the first macroblock of the next slice, and the macroblocks are not allowed to overlap between the slices. Once a screen size is defined, the number of macroblocks per screen is uniquely determined.

The number of macroblocks in the vertical direction and the number of macroblocks in the horizontal direction on the screen are referred to as mb_height and mb_width, respectively. As defined, the coordinates of a macroblock on the screen are expressed by mb_row in which the macroblock vertical position number starts with 0 from the top end, and mb_column in which the macroblock horizontal position number starts with 0 from the left end. In order to express macroblock positions on the screen using a single variable, macroblock_address is defined in the following way:

macroblock_address=mb_row+mb_width +mb_column.

It is defined that the slices and the macroblocks be each ordered in the stream according to the ascending order of macroblock_address. That is, the stream is transmitted from the top to the bottom and from the left to the right of the screen.

In MPEG, typically, one slice is formed of one stripe (16 lines), and variable-length coding starts at the left side and ends at the right side of the screen. Therefore, if a VTR is used to record an MPEG elementary stream without modification, portions capable of being played when played back at a high rate are concentrated in the left side of the screen, preventing uniform refreshing. Furthermore, since the location of data on the tape cannot be predicted, the screen cannot be uniformly refreshed if the tape pattern is traced at a constant rate. Moreover, an error which occurs at one location would influence up to the right side of the screen, resulting in no recovery until the next slice header has been detected. In order to avoid such an inconvenience, one slice is constituted by one macroblock.

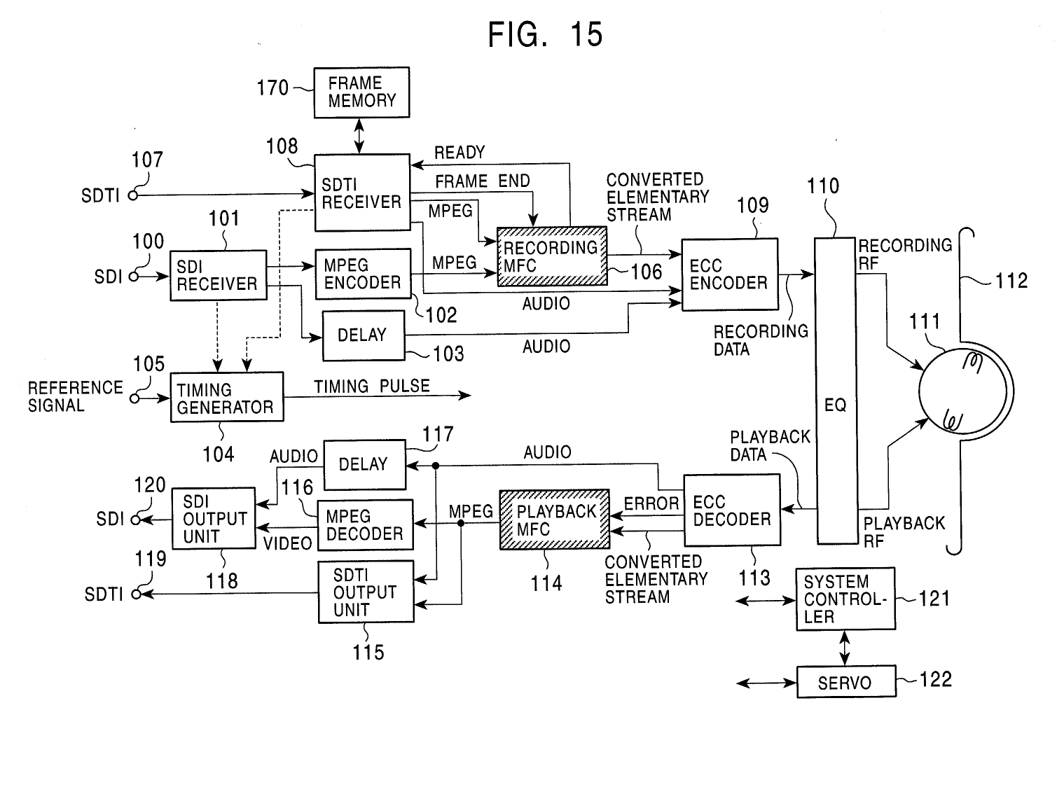

FIG. 15 shows the structure of an example recorder/player according to this embodiment. For recording, a digital signal input from a terminal 100 is fed to an SDI (Serial Data Interface) receiver 101. SDI is an interface which is regulated by SMPTE to transmit a (4:2:2) component video signal, a digital audio signal, and additional data. The SDI receiver 101 extracts a digital video signal and a digital audio signal from the input digital signal. The digital video signal is delivered to an MPEG encoder 102, and the digital audio signal is delivered to an ECC encoder 109 through a delay unit 103. The delay unit 103 serves to eliminate a difference in time between the digital audio signal and the digital video signal.

The SDI receiver 101 also extracts a synchronization signal from the input digital signal, and supplies the extracted synchronization signal to a timing generator 104. An external synchronization signal may also be input to the timing generator 104 from a terminal 105. The timing generator 104 generates timing pulses according to the specified signal among these input synchronization signals and a synchronization signal fed from an SDTI receiver 108 as described later. The generated timing pulses are fed to components of the recorder/player.

An input video signal is subjected to DCT processing in the MPEG encoder 102 for conversion into coefficient data, so that the coefficient data is variable-length coded. The variable-length coded (VLC) data from the MPEG encoder 102 is an elementary stream (ES) complying with MPEG-2. The resultant output is passed to a first input terminal of a recording multi-format converter (hereinafter referred to as “MFC”) 106.

On the other hand, SDTI-format data is input through an input terminal 107. This signal is synchronously detected by the SDTI receiver 108. The resultant signal is buffered in a frame memory 170, and the elementary stream is then extracted. The extracted elementary stream, of which the read timing is controlled by a “ready” signal delivered from the recording MFC 106, is read from the frame memory 170, and is then fed to a second input terminal of the recording MFC 106. The resulting synchronization signal synchronously detected by the SDTI receiver 108 is passed to the timing generator 104.

In one embodiment, for example, SDTI (Serial Data Transport Interface)-CP (Content Package) is used to transmit the MPEG ES (MPEG elementary stream). This ES is a 4:2:2 component, and is a stream consisting of I-pictures, haivng a relationship of 1 GOP=1 picture. In the SDTI-CP format, MPEG ES is separated to access units, and is packed in packets for each frame. SDTI-CP uses a sufficient transmission bandwidth (27 MHz or 36 MHz as the clock rate, and 270 Mbps or 360 Mbps as the stream bit rate), allowing ES to be transmitted in a burst mode in one frame.

Specifically, system data, a video stream, an audio stream, and AUX data are arranged from SAV (Start of Active Video) to EAV (End of Active Video) in one frame. The data are not entirely distributed over one frame, but are distributed in a burst mode in a predetermined period from the beginning of that frame. An SDTI-CP stream (video and audio) can be switched as a stream at frame boundaries. SDTI-CP has a mechanism which establishes audio-video synchronization for the content using an SMPTE time code as a clock reference. The formats are defined so that SDTI-CP and SDI may coexist.

The SDTI receiver 108 outputs an enable signal “enable” indicating a data valid period based on the input stream. The enable signal is a high-level signal in a period during which the data is valid, and a low-level signal in a period during which the data is invalid, by way of example. The enable signal may be delivered to the recording MFC 106.

The above-described interface using SDTI-CP does not require that an encoder and a decoder be passed through VBV (Video Buffer Verifier) buffers and TBs (Transport Buffers) as in the case where TS (transport Stream) is transferred, thereby reducing the delay. Since SDTI-CP itself provides an extremely high transfer rate, the delay can be further reduced. Therefore, in the environment where synchronization is achieved so that the overall broadcast station can be managed, it is effective to use SDTI-CP.

The SDTI receiver 108 further extracts a digital audio signal from the input SDTI-CP stream. The extracted digital audio signal is supplied to the ECC encoder 109.

In this embodiment, based on the input SDTI-CP stream, the SDTI receiver 108 generates and outputs a “Frame End” signal for each frame which is synchronized with the last data of that frame. The “Frame End” signal is delivered to the recording MFC 106. The “Frame End” signal is described in more detail later.

The recording MFC 106 incorporates a selector and a stream converter. The recording MFC 106 and a playback MFC 114 as described later are commonly used, for example, by switching the modes. The processing in the recording MFC 106 is described. The selector is used to select either MPEG ES supplied from the MPEG encoder 102 or from the SDTI receiver 108, which is then supplied to the stream converter.

The stream converter groups the DCT coefficients, which have been organized for each DCT block according to the MPEG-2 standard, on a frequency component basis for a plurality of DCT blocks constituting one macroblock, and groups of frequency components are further reorganized. When one slice is formed of one stripe, the stream converter makes one slice formed of one macroblock. The stream converter further limits the maximum length of the variable length data generated in one macroblock to a fixed length. This is achievable by setting high-order DCT coefficients at 0.

As described in detail later, the stream converter detects the sequence extension 3 subsequent to the sequence header 2 of the supplied MPEG ES to extract information chroma_format indicating a chroma format from the sequence extension 3. Based on the extracted chroma format information, the stream converter controls the process timing of the input MPEG ES so that the chroma formats 4:2:2 and 4:2:0 may be commonly processed.

The converted elementary stream which is reorganized by the recording MFC 106 is supplied to the ECC encoder 109. The ECC encoder 109 is connected to a main memory (not shown) having a large capacity, and includes a packing and shuffling unit, an audio outer encoder, a video outer encoder, an inner encoder, an audio shuffling unit, and a video shuffling unit. The ECC encoder 109 further includes a circuit for adding IDs to each sync block, and a circuit for adding synchronization signals. For example, the ECC encoder 109 may comprise a single integrated circuit.

In one embodiment, a product code is used as an error correcting code for video data and audio data. The product code is used to encode a two-dimensional array of video data or audio data in the vertical and horizontal directions with an outer code and an inner code, respectively, so that data symbols can be doubly encoded. Reed-Solomon codes may be used as the outer code and the inner code.

The process performed by the ECC encoder 109 is described. Since the video data in the converted elementary stream has been variable-length coded, the length is non-uniform from one macroblock to another. In the packing and shuffling unit, a macroblock is put into a fixed frame. An overflow portion which extends beyond the fixed frame is sequentially put into an emptied area of the fixed frame.

The system data having information such as picture formats and versions of shuffling pattern is supplied from a system controller 121 as described later, and is input from an input terminal (not shown). The system data is fed to the packing and shuffling unit, and is recorded in the same manner as picture data. The system data is recorded as video AUX. Then, shuffling is performed such that macroblocks of one frame which are generated in the scan order are reorganized so that the recording positions of macroblocks on the tape are dispersed. The shuffling provides an improved refreshing ratio for the picture even if data is fragmentarily played back when played back at variable rates.

The video data and system data (hereinafter simply referred to as “video data” even if it contains the system data, unless necessary) from the packing and shuffling unit are supplied to a video outer encoder for encoding video data with the outer code, and outer parity is added thereto. The output of the outer encoder is shuffled by the video shuffling unit to reorder a plurality of ECC blocks for each sync block. The shuffling for each sync block prevents concentration of errors in a specific ECC block. The shuffling performed by the shuffling unit may be sometimes referred to as “interleave.” The output of the video shuffling unit is written to the main memory.

As described above, on the other hand, the digital audio signal output from the SDTI receiver 108 or the delay unit 103 is fed to the ECC encoder 109. This embodiment handles uncompressed digital audio signal. The digital audio signal is not limited thereto, and may be input via an audio interface. An audio AUX may be further fed from an input terminal (not shown). The audio AUX represents auxiliary data having information relating to audio data such as the sampling frequency of audio data. The audio AUX is added to the audio data, and may be equivalent to audio data.

The audio data to which the audio AUX is added (hereinafter simply referred to as “audio data” even if it contains the audio AUX, unless necessary) is supplied to an audio outer encoder for encoding audio data with the outer code. The output of the audio outer encoder is supplied to the audio shuffling unit for shuffling. The audio shuffling includes shuffling for each sync block, and shuffling for each channel.

The output of the audio shuffling unit is written to the main memory. As described above, the main memory has the output of the video shuffling unit written thereto, and the audio data and the video data are combined within the main memory to form one channel data.

Data is read from the main memory, to which an ID having information indicating a sync block number is added, and is then supplied to the inner encoder. The inner encoder encodes the supplied data with the inner code. In response to the output of the inner encoder, a synchronization signal for each sync block is added to form recording data having a series of sync blocks.

The recording data output from the ECC encoder 109 is supplied to an equalizer 110 including a recording amplifier for conversion into a recording RF signal. The recording RF signal is delivered to a rotating drum 111 having a rotation head mounted thereto, and is recorded on a magnetic tape 112. A plurality of magnetic heads having different azimuths of heads which form adjacent tracks are mounted to the rotating drum 111.

The recording data may be scrambled, if necessary. It may also be digitally modulated when it is recorded, or may be Partial Response Class 4 coded and Viterbi coded. The equalizer 110 incorporates both a recording mechanism and a playback mechanism.

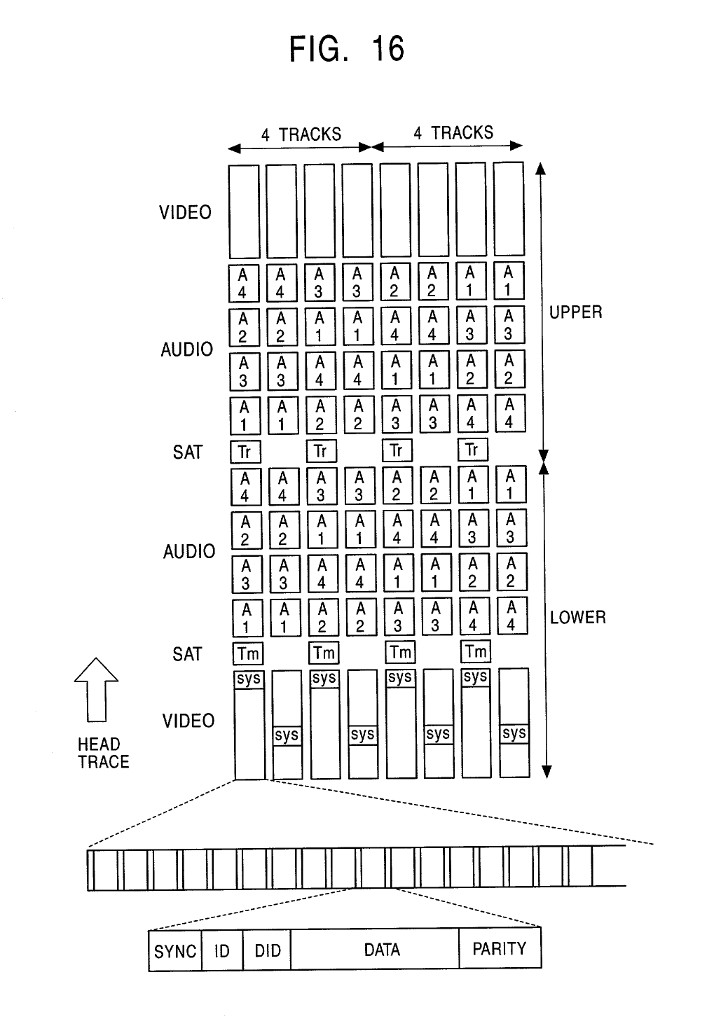

FIG. 16 shows an example track format which is formed on a magnetic tape by the above-described rotation head. In this example, video and audio data of one frame are recorded in four tracks. Adjacent two tracks having different azimuths constitute one segment. That is, four tracks are composed of two segments. One set of tracks constituting a segment is labeled with track number [0] and track number [1] so as to correspond to the azimuths. Each of the tracks includes video sectors at both ends for recording video data, and an audio sector between the video sectors for recording audio data. FIG. 16 shows the locations of the sectors on the tape.

In this example, 4-channel audio data can be used. First to fourth channels of the audio data are indicated by symbols A1 to A4, respectively. The audio data are reordered for each segment before being. In this example, the data corresponding to four error correcting blocks with respect to one track are interleaved, and are divided into an upper side sector and a lower side sector before being recorded.

The video sector in the lower side includes system areas (SYS). The system areas may be alternately located every track in the proximity to the leading end and in the proximity of the trailing end of the video sector in the lower side.

In FIG. 16, SAT indicates an area in which a servo lock signal is recorded. There are gaps between the recording areas.

While FIG. 16 shows an example where data per frame are recorded in four tracks, the data per frame can be recorded in 8 tracks, 6 tracks, or the like, depending upon the format of data to be recorded and played back.

Still referring to FIG. 16, each data recorded on the tape is composed of a plurality of blocks, called sync blocks, which are partitioned at an equal interval. Each sync block includes a SYNC pattern for synchronous detection, an ID for identifying the sync blocks, a DID indicating the content of the data subsequent thereto, data packets, and inner parity for error correction. The data is handled as packets for each sync block. In short, the minimum data unit to be recorded or played back corresponds to one sync block. For example, an array of multiple sync blocks may form a video sector.

Returning back to FIG. 15, the playback signal played back by the rotating drum 111 from the magnetic tape 112 is supplied to the playback system of the equalizer 110, including a playback amplifier, for playback. The playback signal is then equalized or wave-shaped in the equalizer 110. The playback signal is further digitally decoded or Viterbi decoded, if necessary. The output of the equalizer 110 is delivered to the ECC decoder 113.

The ECC decoder 113 performs processes inverse to the processes previously described with respect to the ECC encoder 109, and includes a main memory having a large capacity, an inner decoder, an audio deshuffling unit, a video deshuffling unit, and an outer decoder. The ECC decoder 113 further includes a deshuffling and depacking unit and a data interpolation unit for video decoding, and an audio AUX separating unit and a data interpolation unit for audio decoding. For example, the ECC decoder 113 may comprise a single integrated circuit.

The process performed by the ECC decoder 113 is described. The ECC decoder 113 first performs synchronous detection to detect synchronization signals applied to the beginning of sync blocks to break the sync blocks. The playback data is supplied to the inner decoder for each sync block, on which an error correction is performed with the inner code. The output of the inner decoder is subjected to ID interpolation to interpolate the ID, such as sync block number, of the sync block in which an error is detected with the inner code. The playback data in which the ID is interpolated is separated into video data and audio data.

As described above, video data means DCT coefficient data and system data which are generated by intra-coding in MPEG, and audio data means PCM (pulse code modulation) data and audio AUX.

The separated audio data is delivered to the audio deshuffling unit for processing inverse to shuffling performed in the recording shuffling unit. The output of the deshuffling unit is supplied to the audio outer decoder for error correction with the outer code. The audio data which is subjected to error correcting is output from the audio outer decoder. An error flag would be set for the data containing an uncorrectable error.

The audio AUX is separated from the output of the audio outer decoder by the audio AUX separating unit, and the separated audio AUX is output from the ECC decoder 113 (the routing is omitted). The audio AUX is fed to, for example, the system controller 121 as described later. The audio data is supplied to the data interpolation unit. The data interpolation unit interpolates a sample containing an error. Interpolation methods include mean interpolation in which mean of temporally previous and next correct data is used for interpolation, and 0th-order pre-hold in which the previous correct sample value is held.

The output of the data interpolation unit corresponds to the output of the audio data from the ECC decoder 113, and the audio data output from the ECC decoder 113 is delivered to a delay unit 117 and an SDTI output unit 115. The delay unit 117 serves to absorb the delay due to the video data processed in an MPEG decoder 116 as described later. The audio data delivered to the delay unit 117 is supplied to an SDI output unit 118 with delay.

The separated video data is delivered to the deshuffling unit for the processing inverse to shuffling performed in the recording shuffling unit. The deshuffling unit deshuffles each sync block which has been shuffled by the recording shuffling unit. The output of the deshuffling unit is supplied to the outer decoder for error correction with the outer code. If an uncorrectable error is generated, an error flag indicating the presence or absence of an error indicates the presence of an error.

The output of the outer decoder is supplied to the deshuffling and depacking unit. The deshuffling and depacking unit deshuffles each macroblock which has been shuffled by the recording packing and shuffling unit. The deshuffling and depacking unit further depacks each macroblock which has been packed when it is recorded. More specifically, the length of data is recovered for each macroblock to restore the original variable length code. The deshuffling and depacking unit further separates the system data, which is then output from the ECC decoder 113 and is passed to the system controller 121 as described later.

The output of the deshuffling and depacking unit is delivered to the data interpolation unit, where the data in which an error flag is on, i.e., the data having an error, is corrected. If an error generated around the middle of macroblock data is detected before conversion, the DCT coefficients of the frequency components after the error position cannot be restored. Thus, for example, the DCT coefficients of the frequency components after the error position are set zero. Likewise, the only DCT coefficients having up to the length corresponding to the sync block length are restored during playback at a high rate, and the coefficients thereafter are replaced with zero data. Furthermore, if a header at the beginning of the video data contains an error, the data interpolation unit functions to recover the header (the sequence header, the GOP header, the picture header, or the user data).

The video data and the error flag output from the data interpolation unit correspond to the output of the ECC decoder 113, and the output of the ECC decoder 113 is supplied to a playback multi-format converter (hereinafter referred to as “playback MFC”) 114. The playback MFC 114 performs a process inverse to the process performed by the recording MFC 106, and includes a stream converter. For example, the playback MFC 114 may comprise a single integrated circuit.

The stream converter uses the error flag from the data interpolation unit to add an EOB (End Of Block) signal in position to video data containing an error in order to truncate the data. Since the DCT coefficients are organized across DCT blocks from the DC component and low-frequency components to high-frequency components, the DCT coefficients can be thoroughly distributed over the DCT blocks constituting a macroblock from the DC component and low-frequency components if the DCT coefficients after a particular position are ignored.

The stream converter further performs a process inverse to the process performed by the recording stream converter. More specifically, the DCT coefficients which are organized on a frequency component basis for DCT blocks are reorganized for units of DCT block. The playback MFC 114 detects the sequence extension 3 from the supplied stream to extract chroma format information. When the above-noted reorganization of the DCT coefficients is performed by the stream converter, a timing control is performed based on the extracted chroma format information. Therefore, the playback signal is converted into an elementary stream complying with MPEG-2.

The input/output of the stream converter maintains a sufficient transfer rate (bandwidth) according to the maximum length of a macroblock as in the recording stream converter. If the length of macroblocks (slices) is not limited, the bandwidth three times the pixel rate is preferably maintained.

The output of the stream converter corresponds to the output of the playback MFC 114, and the output of the playback MFC 114 is supplied to the SDTI output unit 115 and the MPEG decoder 116.

The MPEG decoder 116 decodes the elementary stream to output video data. That is, inverse quantization and the inverse DCT are performed in the MPEG decoder 116. The decoded video data is fed to the SDI output unit 118. As described above, the audio data which is separated from the video data by the ECC decoder 113 is supplied to the SDI output unit 118 via the delay unit 117. In the SDI output unit 118, the supplied video data and audio data are mapped with the SDI format, and are converted into a stream having a data structure in the SDI format. The stream from the SDI output unit 118 is output through an output terminal 120 to the outside.

On the other hand, as described above, the audio data which is separated from the video data by the ECC decoder 113 is supplied to the SDTI output unit 115. In the SDTI output unit 115, the supplied video data as an elementary stream and the audio data are mapped with the SDTI format, and are converted into a stream having a data structure in the SDTI format. The converted stream is output through an output terminal 119 to the outside.

In FIG. 15, for example, the system controller 121 may comprise a microcomputer for controlling the overall operation of the recorder/player. The servo 122 communicates with the system controller 121 to control to travel the magnetic tape 112 or to drive the rotating drum 111.

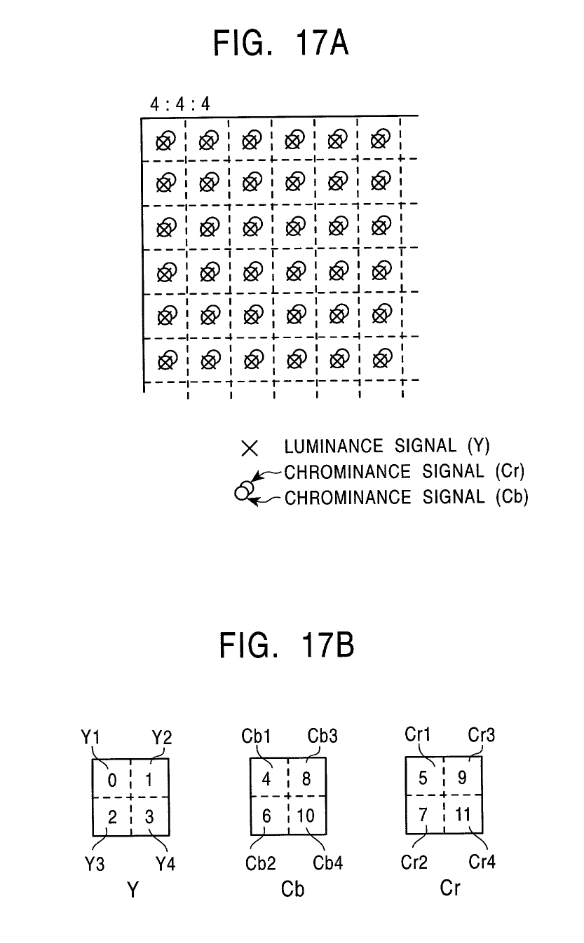

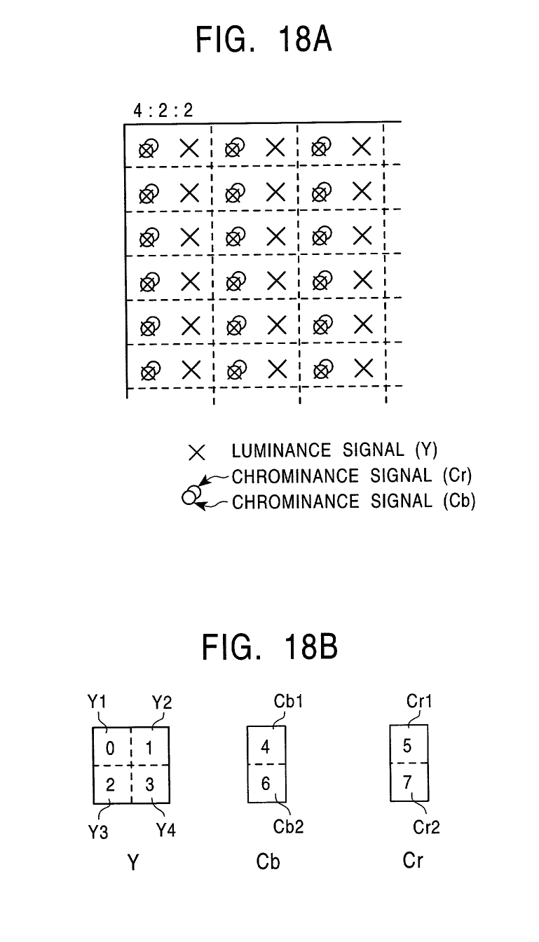

Chroma formats are schematically described with reference to FIGS. 17A and 17B, FIGS. 18A and 18B, and FIGS. 18A and 18B which illustrate chroma formats 4:4:4, 4:2:2, and 4:2:0, respectively. FIGS. 17A, 18A, and 19A show the size and sampling phase of luminance signal Y and chrominance signals Cb and Cr. In the figures, symbol “×” denotes the phase of the luminance signal Y, and two overlapping circles denote the phase of the chrominance signals Cb and Cr.

FIG. 17A shows chroma format 4:4:4, in which matching is found in size and sampling phase between the chrominance signals Cb and Cr and the luminance signal Y. If four DCT blocks each including 8×8 pixels form one macroblock, as shown in FIG. 17B, the matrix of the chrominance signals Cb and Cr is created by four blocks having the same size as the matrix of the luminance signal y in the horizontal and vertical dimensions.

FIG. 18A shows chroma format 4:2:2, in which the size of the chrominance signals Cb and Cr is reduced by half the size of the luminance signal Y in the horizontal direction. In view of one macroblock, therefore, the matrix of the chrominance signals Cb and Cr is reduced by half the matrix of the luminance signal Y in the horizontal direction.

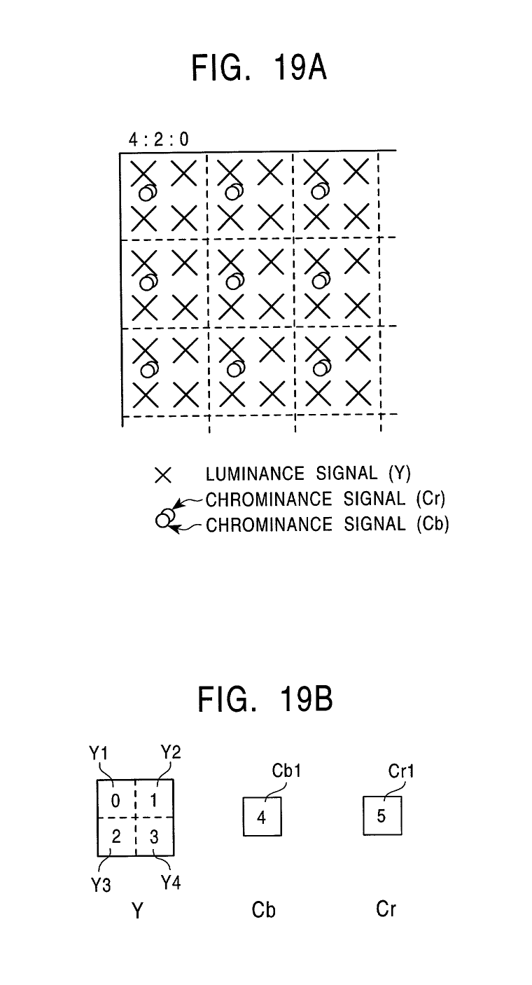

FIG. 19A shows chroma format 4:2:0, in which the size of the chrominance signals Cb and Cr is reduced by half the size of the luminance signal Y in both horizontal and vertical dimensions. In view of one macroblock, therefore, the matrix of the chrominance signals Cb and Cr is reduced by half the matrix of the luminance signal Y in both horizontal and vertical dimensions.

As shown in FIGS. 17B, 18B, and 19B, the DCT blocks forming each macroblock are numbered from the upper left corner. In chroma format 4:4:4, as shown in FIG. 17B, the blocks in each macroblock are encoded in the order of Y₁, Y₂, Y₃, Y₄, Cb₁, Cr₁, Cb₂, Cr₂, Cb₃, Cr₃, Cb₄, and Cr₄. In chroma format 4:2:2, as shown in FIG. 18B, the blocks in each macroblock are encoded in the order of Y₁, Y₂, Y₃, Y₄, Cb₁, Cr₁, Cb₂, and Cr₂. In chroma format 4:2:0, as shown in FIG. 19B, the blocks in each macroblock are encoded in the order of Y₁, Y₂, Y₃, Y₄, Cb₁, and Cr₁.

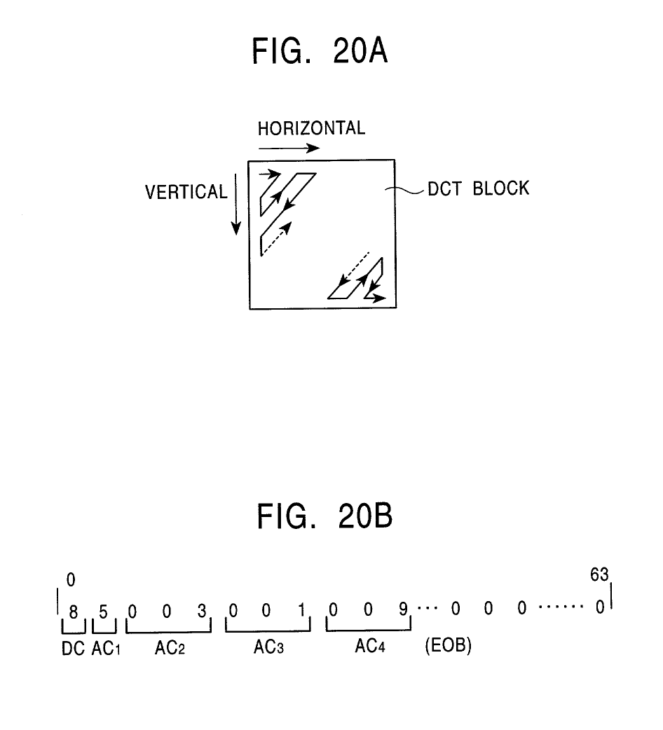

FIG. 20A shows the scan order of the DCT coefficients in the video data output from a DCT circuit in the MPEF encoder 102. MPEG ES output from the SDTI receiver 108 is the same. In the following description, the output of the MPEG encoder 102 is employed, by way of example. The DCT coefficients are output using a zigzag scan pattern from the upper left DC component in the DCT block toward the components having higher horizontal and vertical spatial frequencies. As a result, as an example shown in FIG. 20B, total 64 (8 pixels by 8 lines) DCT coefficients are organized in the order of frequency components.

The resultant DCT coefficients are variable-length coded by a VLC unit in the MPEG encoder 102. The first coefficient is fixed as the DC component, and codes are allocated to the remaining components (AC components) so as to correspond to a run of zeros followed by levels. Therefore, the variable-length coded outputs of the coefficient data of the AC components are organized from low-frequency (low-order) components to high-frequency (high-order) components, such as AC₁, AC₂, AC₃, etc. The variable-length coded DCT coefficients are contained in the elementary stream.

In the recording stream converter incorporated in the recording MFC 106, the DCT coefficients in the supplied signal are reorganized. Specifically, the DCT coefficients, which are organized in the order of frequency components for each DCT block by a zigzag scan, are reorganized in the order of frequency components across the DCT blocks constituting a macroblock.

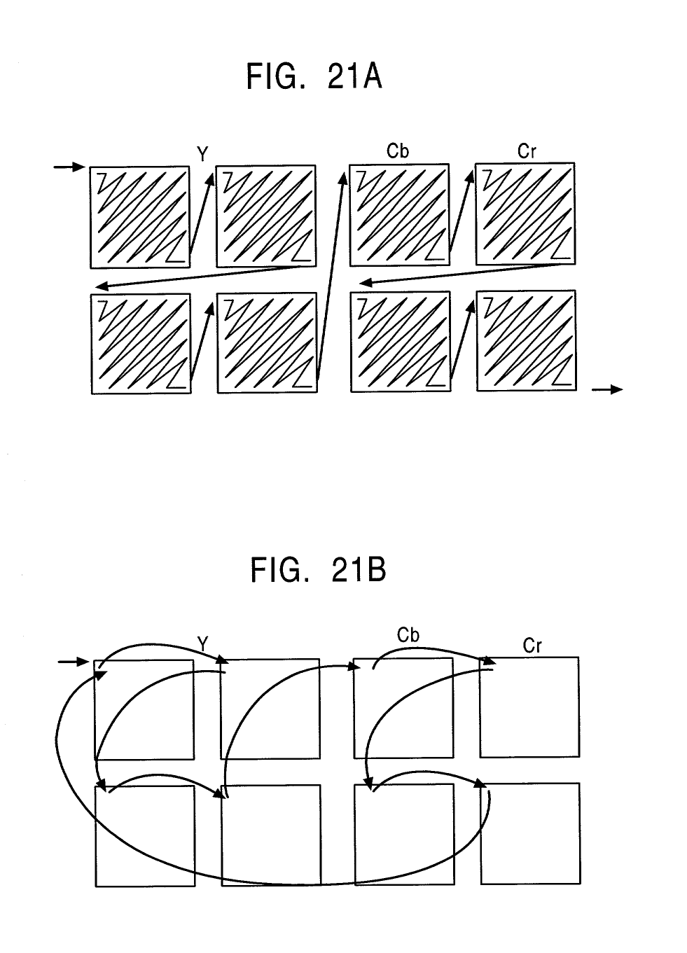

FIGS. 21A and 21B schematically show the reorganization of the DCT coefficients in the recording stream converter. For a (4:2:2) component signal, one macroblock is formed of four DCT blocks (Y₁, Y₂, Y₃, and Y₄) of the luminance signal Y, and two DCT blocks (Cb₁, Cb₂, Cr₁, and Cr₂) of each of the chrominance signals Cb and Cr.

As described above, in the MPEG encoder 102, through a zigzag scan according to the MPEG-2 algorithm, the DCT coefficients are organized in the order of frequency components from the DC component and low-frequency components to high-frequency components in each DCT block, as shown in FIG. 21A. When a scan of one DCT block is completed, another scan of the next DCT block is initiated to organize the DCT coefficients in the same way.

Therefore, the DCT coefficients are organized in the order of frequency components from the DC component and low-frequency components to high-frequency components in the DCT blocks Y₁, Y₂, Y₃, and Y₄, and the DCT blocks Cb₁, Cr₁, Cb₂, and Cr₂ of a macroblock. The DCT coefficients are then variable-length coded so that codes of [DC, AC₁, AC₂, AC₃, etc.] are allocated to the DCT coefficients so as to correspond to a set of run followed by levels.

The recording stream converter decodes the variable length code of the variable-length coded and organized DCT coefficients to detect the segmentation of the DCT coefficients, and groups the DCT coefficients on a frequency component basis for the DCT blocks constituting a macroblock. This process is shown in FIG. 21B. First, the DC components of eight DCT blocks in a macroblock are grouped, the lowest-frequency AC components of the eight DCT blocks are grouped, and the same-order AC components in the remaining coefficients are grouped in turn, so that the coefficient data can be reorganized across the eight DCT blocks.

The reorganized coefficient data is in the order of DC (Y₁), DC (Y₂), DC (Y₃), DC (Y₄), DC (Cb₁), DC (Cr₁), DC (Cb₂), DC (Cr₂), AC₁, (Y₁), AC₁ (Y₂), AC₁ (Y₃), AC₁ (Y₄), AC₁ (Cb₁), AC₁ (Cr₁), AC₁ (Cb₂), AC₁ (Cr₂), etc. As used herein, DC, AC₁, AC₂, etc. are variable length codes allocated to the set of run followed by levels, as described above with reference to FIG. 20B.

The converted elementary stream having coefficient data reordered in the recording stream converter is supplied to the packing and shuffling unit contained in the ECC encoder 109. The data length of a macroblock in converted elementary streams is the same as that in unconverted elementary streams. In the MPEG encoder 102, if the length is fixed for units of GOP (one frame) due to a bit rate control, the length varies for units of macroblock. In the packing and shuffling unit, the macroblock data are put into a fixed frame.

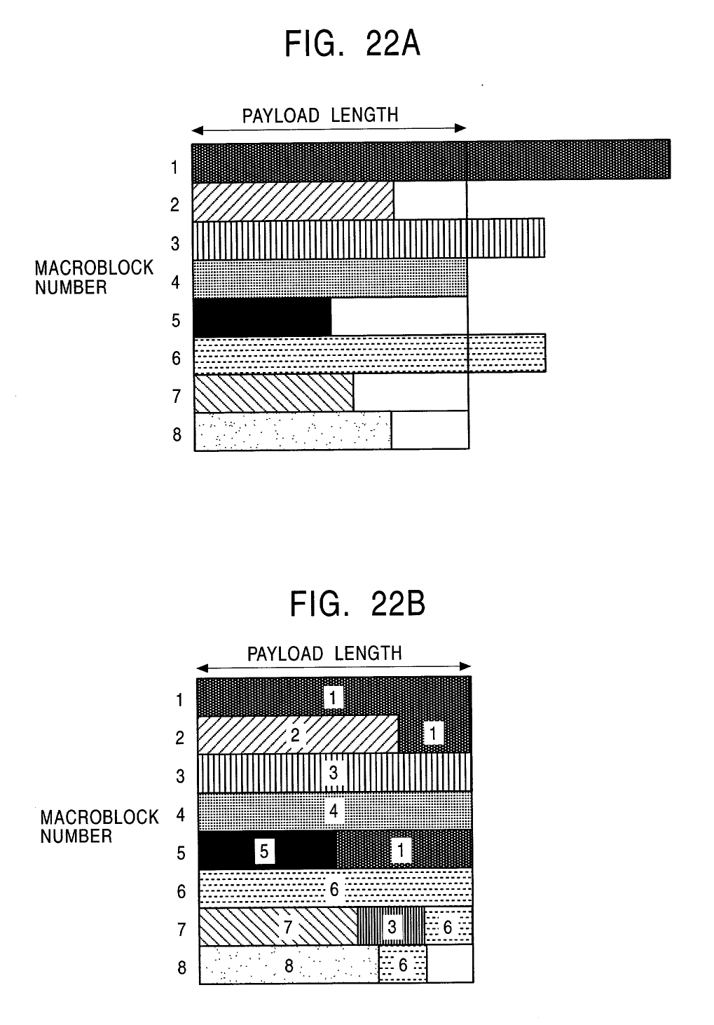

FIGS. 22A and 22B schematically show the packing process for a macroblock in the packing and shuffling unit. The macroblock is put into a fixed frame having a fixed data length, and is then packed. The data length of this fixed frame matches the data length of a payload which provides a data storage area in a sync block that is the minimum data unit for recording and playback. This is because shuffling and error correction encoding are simplified. For simplicity, one frame contains eight macroblocks in FIGS. 22A and 22B.

As an example shown in FIG. 22A, the lengths of the eight macroblocks are different after variable length coding. In this example, the data lengths of macroblock 1, macroblock 3, and macroblock 6 are longer, and the data lengths of macroblock 2, macroblock 5, macroblock 7, and macroblock 8 are shorter than the length of the data area (payload) of one sync block or a fixed frame. The data length of macroblock 4 is the same as the length of the payload.

The packing process causes the macroblocks to be packed into a fixed length frame of the payload length. The data can be packed, without under- or overflowing, into the fixed frame because the quantity of data which is generated in one frame is controlled to be fixed. As an example shown in FIG. 22B, the macroblock having a longer length than the payload is divided at a position corresponding to the payload length. The portion (overflow portion) of the divided macroblock which overflows the payload length is packed into emptied regions from the top, i.e., is packed after the macroblock having a shorter length than the payload length.

In the example of FIG. 22B, the portion of macroblock 1 which overflows the payload length is first packed after macroblock 2, and is then packed after macroblock 5 once reaching the payload length. The portion of macroblock 3 which overflows the payload length is packed after macroblock 7. The portion of macroblock 6 which overflows the payload length is packed after macroblock 7, and the still overflowing portion is packed after macroblock 8. Accordingly, the macroblocks are packed in a fixed frame of the payload length.

The length of the variable-length coded data for each macroblock can be learned in advance in the recording stream converter. This enables the packing unit to know the end of the data of the macroblocks without decoding the VLC data to check the content.

As described above, in this embodiment, the DCT coefficients are reorganized in a macroblock, and the macroblock data is packed in a payload for units of one picture. This reduces the deterioration in picture quality even if a dropout of a tape, etc. cause an error beyond the error correction capability of the error correcting code due to

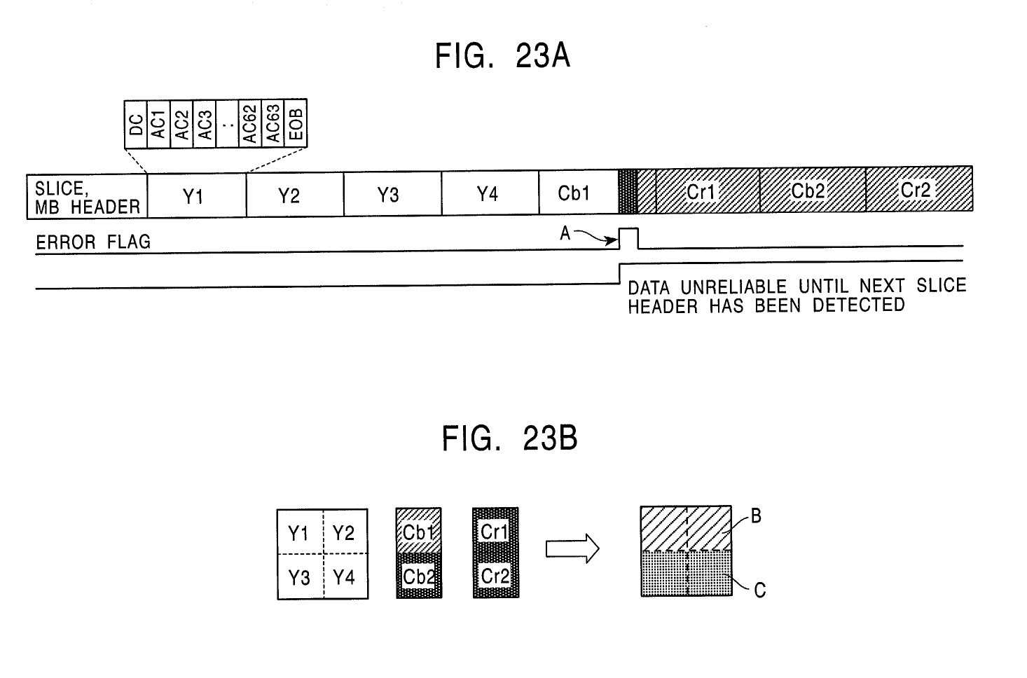

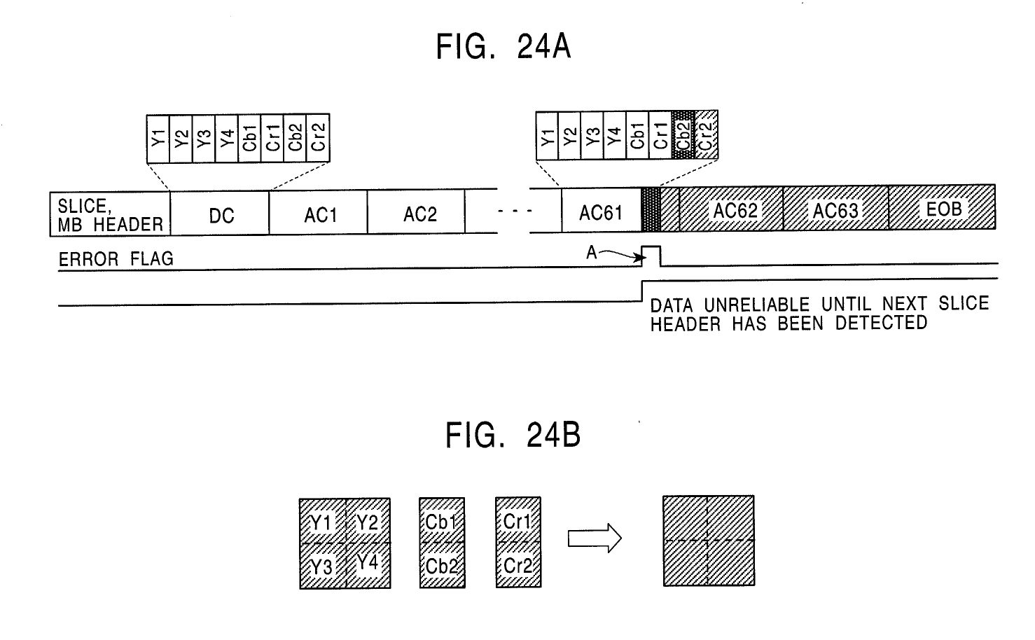

The advantages of the reorganization of coefficients and the packing process are described with reference to FIGS. 23A, 23B, 24A, and 24B. In the following description, chroma format 4:2:2 is employed, by way of example. FIGS. 23A and 23B show that the DCT blocks and the DCT coefficients are supplied in a similar manner to MPEG ES. In this case, as shown in FIG. 23A, after a slice header or a macroblock (MB) header, DCT blocks are organized in the order of the luminance signals Y₁ to Y₄, and the chrominance signals Cb₁, Cr₁, Cb₂, and Cr₂. In each of the blocks, the DCT coefficients are organized from the DC component and low-order AC components to high-order AC components.

As an example, it is assumed that an error occurs in a timing of position A in FIG. 23A beyond the error correction capability of the error correcting code, namely, a high-order coefficient of the block Cb₁. As previously described, a slice forms a single variable length code sequence in the MPEG algorithm. Once an error occurs, therefore, the data is unreliable from the error position until the next slice header has been detected. Therefore, the data after the position A in this macroblock cannot be decoded in the stream formed of one slice equal to one macroblock.

As a result, as an example shown in FIG. 23B, even the DC components of the chrominance signal blocks Cr₁, Cb₂, and Cb₂ cannot be restored. Since high-order components of the block Cb₁ and the other chrominance signal blocks cannot be restored, a picture having an incorrect color produced by the low-order coefficients of the block Cb₁ is created in section B corresponding to the blocks Y₁ and Y₂. A monochrome picture is created in section C corresponding to the blocks Y₃ and Y₄ since only the luminance signal is restored.

FIGS. 24A and 24B show a converted stream in which the DCT coefficients are reorganized according to the embodiment. As in FIGS. 23A and 23B, it is assumed that an error occurs at a position A. As an example shown in FIG. 24A, after a slice header or a macroblock header, blocks each having DCT coefficients grouped on a frequency component basis for DCT blocks are organized from the DC component and low-order AC components to high-order AC components.

The data after the error position A is unreliable until the next slice header has been detected, and the data after the error position A in this macroblock are not therefore restored. In this converted stream, however, the data which cannot be decoded due to the error correspond to the high-order AC components of the DCT coefficients in each DCT block, and the DC component and the low-order AC components of the DCT coefficients in each DCT block are uniformly provided. As shown in FIG. 24B, although the detail of a picture is dropped out because the high-order AC components are not restored, the above-described inconvenience with MPEG ES that a monochrome picture is created or a picture having an incorrect color which fails either of the two chrominance components can be substantially eliminated.

Therefore, the picture quality can be maintained to some extent even if the data stored in other fixed frames by the above-described packing process are not restored. This reduces deterioration in the quality of a picture played back at a high rate.

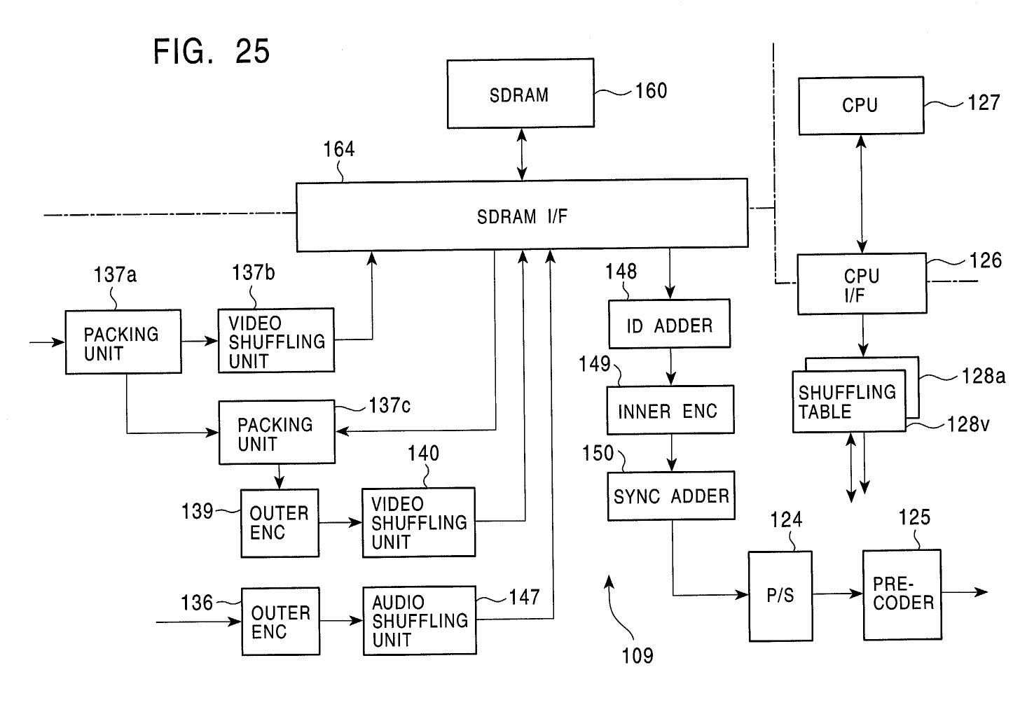

FIG. 25 shows the more detailed structure of the ECC encoder 109. In FIG. 25, an interface 164 interfaces with a main memory 160 externally attached to the IC. The main memory 160 may comprise an SDRAM. The interface 164 relays a request from the internal components to the main memory 160, and allows data to be written/read to/from the main memory 160. A packing and shuffling unit 137 includes a packing unit 137a, a video shuffling unit 137b, and a packing unit 137c.

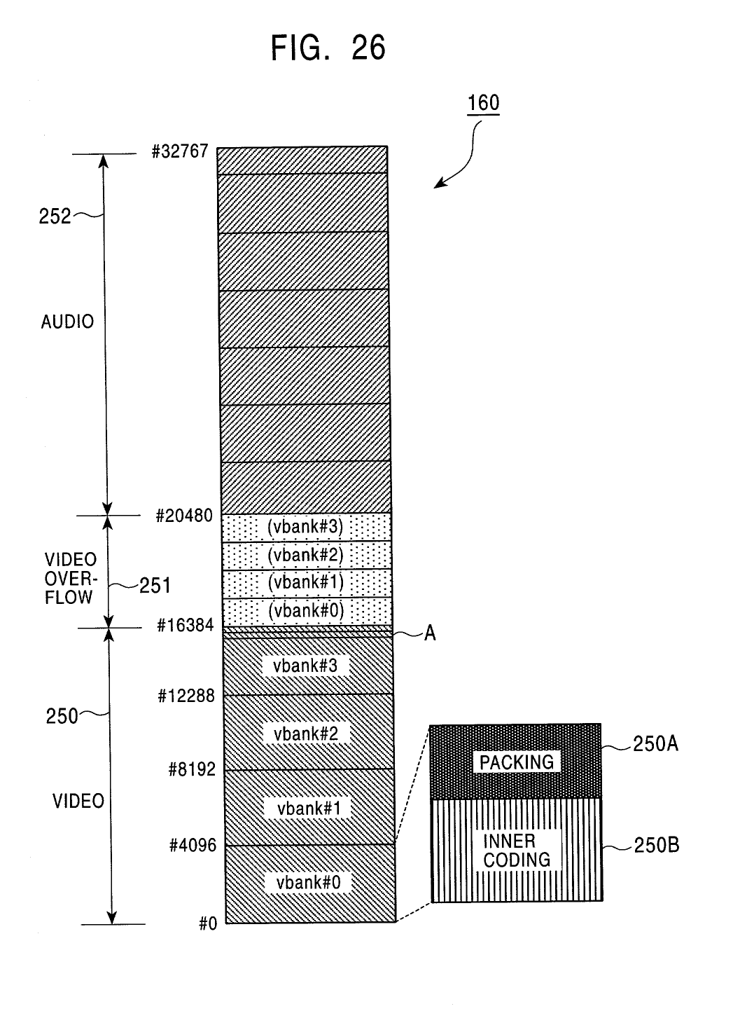

FIG. 26 shows an exemplary address configuration of the main memory 160. The main memory 160 may comprise a 64-Mbit SDRAM. The main memory 160 has a video area 250, a video overflow area 251, and an audio area 252. The video area 250 is formed of four banks (vbank 0, vbank 1, vbank 2, and vbank 3). Each of the four banks can store a digital video signal of one equal-length code. One equal-length code is a unit for controlling the quantity of generated data at a substantially target value, and may be one picture of a video signal (I-picture). In FIG. 26, section A indicates a data section of one sync block of a video signal. A different number of bytes of data are inserted in one sync block from one format to another. In order to support a plurality of formats, the data size of one sync block is through to be more than the maximum bytes and to be bytes suitable for processing, such as 256 bytes.

Each of the banks vbank 0 to vbank 4 in the video area 250 is subdivided into a packing area 250A and an output area 250B to the inner encoder. The video overflow area 251 is composed of four banks to correspond to the video area 250. The audio area 252 in the main memory 160 is provided for processing audio data.

In this embodiment, the packing unit 137a separately stores the fixed frame length data and the overflow data that overflows the fixed frame in different areas of the main memory 160 by referring to a data length flag in each macroblock. The fixed length data is data having a smaller length than the length of the data area (payload) of a sync block, and is hereinafter referred to as “block length data.” The block length data is stored in the packing area 250A in each bank. A data length shorter than the block length may provide an emptied area in the corresponding area of the main memory 160. The video shuffling unit 137b controls write addresses for shuffling. It is noted that the video shuffling unit 137b only shuffles the block length data, and the overflow data is not shuffled and is written to an area allocated to the overflow data.

Then, the packing unit 137c packs and writes the overflow data in a memory of an outer encoder 139. The block length data is written to a memory of one ECC block which is prepared in the outer encoder 139 from the main memory 160, and the overflow data may be written to an emptied region of the block so that that block may be filled with data. Once data of one ECC block is completely written, the write process is temporarily interrupted, and the outer encoder 139 generates outer parity. The outer parity is stored in a memory of the outer encoder 139. When one ECC block has been completely processed in the outer encoder 139, the data from the outer encoder 139 and the outer parity are reordered for inner encoding, and are rewritten to the output area 250B separate from the packing area 250A of the main memory 160. A video shuffling unit 140 controls the address when the outer-coded data is rewritten to the main memory 160 for shuffling for each sync bloc.

Such processes are performed for units of ECC block, including a first packing process to separately write the block length data and the overflow data to the first area 250A of the main memory 160, a second packing process to pack and write the overflow data in a memory of the outer encoder 139, a process to generate outer parity, and a process to rewrite the data and the outer parity in the second area 250B of the main memory 160. Since the outer encoder 139 includes a memory having a ECC block size, the main memory 160 may be less frequently accessed.

When a predetermined number of ECC blocks (for example, 32 ECC blocks) included in one picture have been completely processed, the packing process and outer coding on that picture are completed. Then, the data read from the area 250B of the main memory 160 via the interface 164 is processed by an ID adder 148, an inner encoder 149, and a synchronization adder 150, and the resulting data is converted into bit serial data by a parallel-serial converter 124. The output serial data is then processed by a Partial Response Class 4 precoder 125. The output from the precoder 125 is digitally modulated, if necessary, and is then delivered to the rotation head on the rotating drum 111.

A sync block, called a null sync, which does not include valid data is introduced in an ECC block so that the ECC block may be flexibly constructed regardless of different formats of the recording vide signals. The null sync is generated by the packing unit 137a in the packing and shuffling unit 137, and is written to the main memory 160. Since the null sync includes a data recording area, it can be used as a recording sync for the overflow data.

For audio data, even-numbered samples and odd-numbered samples of audio data in one field separately constitute different ECC blocks. Since an outer code sequence of an ECC block is constituted by entry-sequenced audio samples, the outer encoder 136 generates outer parity each time an audio sample in the outer code sequence is entered. The shuffling unit 137 controls the address when the output of the outer encoder 136 is written to the area 252 of the main memory 160 for shuffling for units of channel and for units of sync block.

A CPU interface 126 is further provided for receiving data from an external CPU 127 functioning as a system controller so that parameters can be set for the internal blocks. In order to support a plurality of formats, a great number of parameters including a sync block length and a parity length can be set.

One parameter is “packing length data” which is transmitted to the packing units 137a and 137c. The packing units 137a and 137c pack the VLC data into a fixed frame (a length referred to as “payload length” shown in FIG. 22A) which is determined based on this parameter.

Another parameter is “number-of-pack data” which is transmitted to the packing unit 137c. The packing unit 137c determines the number of packs per sync block, and delivers the data corresponding to the determined number of packs to the outer encoder 139.

Another parameter is “number-of-video-outer-parity data” which is transmitted to the outer encoder 139. The outer encoder 139 encodes, using the outer code, the video data in which the number of parities based on this parameter is generated.

The parameters include “ID information” and “DID information” which are transmitted to the ID adder 148. The ID adder 148 adds the ID information and the DID information to the data stream having a unit length read from the main memory 160.

The parameters include “number-of-video-inner-parity data” and “number-of-audio-inner-parity data” which are transmitted to the inner encoder 149. The inner encoder 149 encodes, using the inner code, the video data and the audio data in which the number of parities based on these parameters are generated. Another parameter, namely, “sync length data” is also transmitted to the inner encoder 149, and a unit length (sync length) of the inner-coded data is defined based on this parameter.

Another parameter is “shuffling table data” which is stored in a video shuffling table (RAM) 128v and an audio shuffling table (RAM) 128a. The video shuffling table 128v performs an address conversion to help the video shuffling units 137b and 140 shuffle. The audio shuffling table 128a performs an address conversion to help the audio shuffling unit 137 shuffle.

In this embodiment, a “Frame End” signal which is synchronized with the end-of-frame data is used to indicate the end of each frame. This allows the processing every frame to complete at the point when the “Frame End” signal is received. Therefore, the next process can be initiated or can be ready at the point when the “Frame End” signal is received. Accordingly, the “Frame End” signal can reduce the processing delay.

If a failure in a transmission path, etc. cause failed start codes, bit inversion, or the like to prevent the start codes from being detected, the processing on that frame can be completed by detecting the “Frame End” signal. More specifically, if failed start codes, etc. cause inherently valid data to be invalid, a period from the “Frame End” signal to the next start code is ignored. When a correct stream is input, a start code can be immediately responded, resulting in a recovery to provide stable processing from that frame.

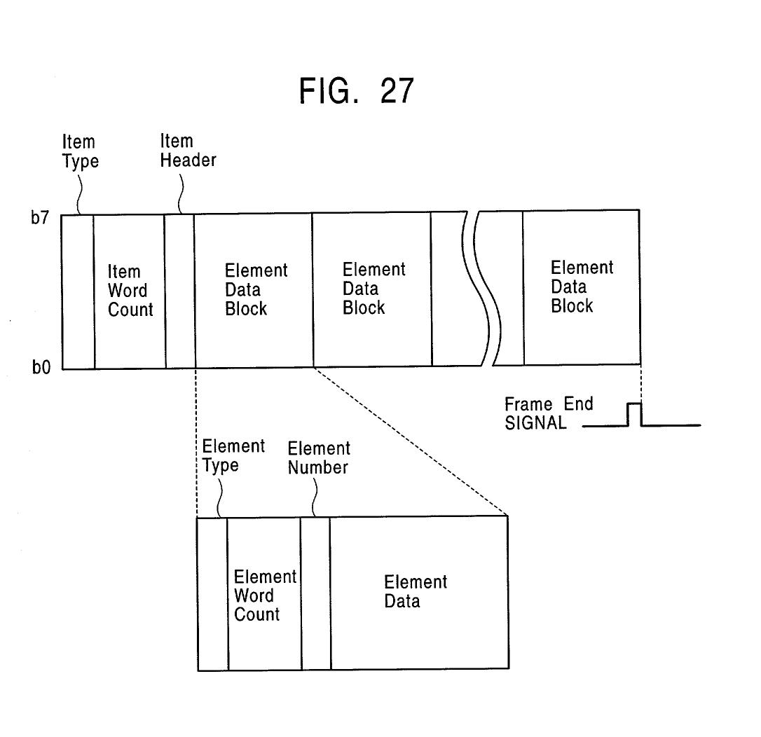

The “Frame End” signal is generated in synchronization with the end-of-frame data based on the SDTI-CP header information. In SDTI-CP, system, picture, audio, and auxiliary items start with separators and end at end codes, and are stored in a variable-length SDTI block which is terminated for each frame. FIG. 27 illustrates the data structure of example items stored in the SDTI block. A block of the item data stored in the SDTI block is hereinafter referred to as “item data block.”

As shown in FIG. 27, an item type indicating the type of item resides at the beginning of the item data block. The item type is followed by an item word count having a data length of four bytes, indicating the active length of the data in this block. The item word count indicates a data length of items after the item word count. The item word count is followed by an item header having a data length of one byte, followed by element data blocks indicating the substance of the items. One item data block includes a plurality of element data blocks. The total number of element data blocks is defined in the item header. The item word count provides a data length of the item header and the element data blocks in the item data block.

Each of the element data blocks includes an element type of one byte indicating the element type at the beginning, followed by an element word count of four bytes indicating an active length of the data in the element data block. The element word count indicates a data length after the element word count in the element data block. The element word count is followed by an element number of one byte, followed by element data in which substantive data of that item is stored. The element word count provides the total number of words in the element number and the element data.

Accordingly, the item data block is a variable-length data block which is terminated for each frame. In this embodiment, the item word count in the item data block is used to determine the position of the data at the end of item data block to generate a “Frame End” signal based on the determined end position. The “Frame End” signal is a pulse which rises in synchronization with the trailing end of the item data block, namely, the data at the end of the overall element data blocks contained in the item data block.

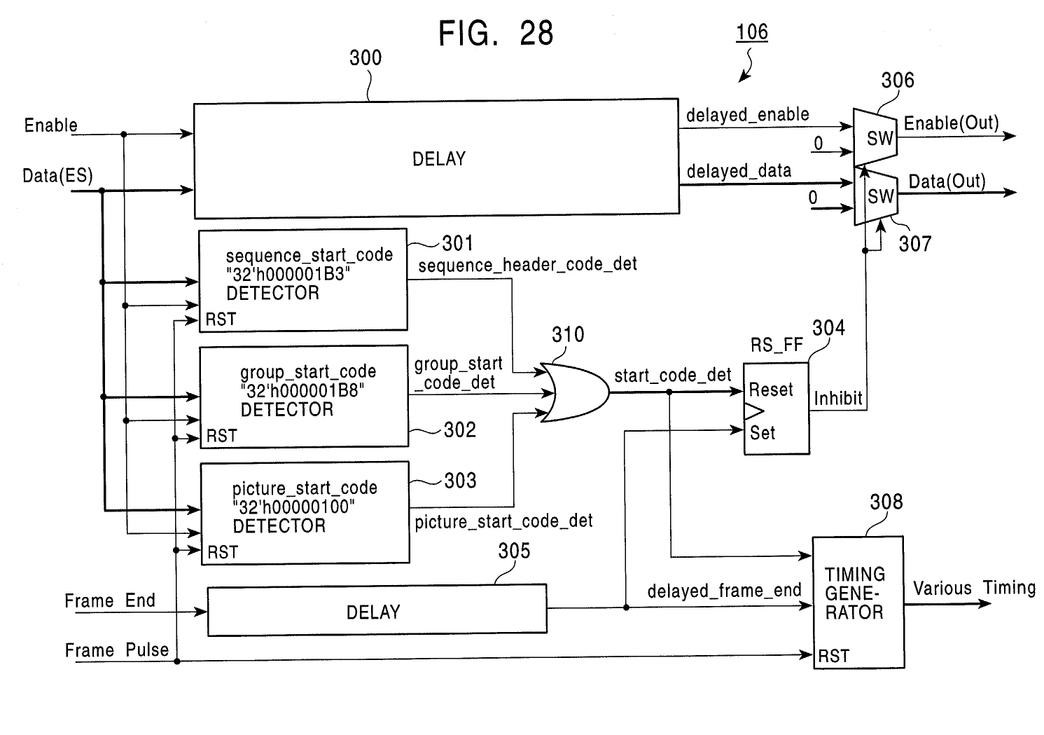

As described above, the “Frame End” signal generated by the SDTI receiver 108 is delivered to the recording MFC 106. FIG. 28 illustrates the structure of the recording MFC 106, by way of example. The “Frame End” signal which is delivered to the recording MFC 106 is passed through a delay circuit 305 for providing a detection delay, and becomes a delayed “Frame-End” signal delayed_frame_end, which is then supplied to a set input of an RS flip-flop circuit (hereinafter referred to as “RS_RR circuit”) 304 and to a timing generator 308.

A frame pulse which is transmitted to detector circuits 301, 302, and 303 for detecting header information of the layers in MPEG and to the timing generator 308 is generated by the timing generator 104, for example, based on a reference signal input from the terminal 105. The frame pulse may be generated in synchronization with the beginning of the frame in SDTI, for example, based on the frame signal. The detector circuits 301, 302, and 303, and the timing generator 308 are reset in response to the frame pulse.

The enable signal and elementary stream which are output from the SDTI receiver 108 are supplied to a delay circuit 300. The delay circuit 300 gives the enable signal and elementary stream a delay for adjusting the detection delay to output a delayed enable signal delayed_enable and a delayed elementary stream delayed_data. The signal delayed_enable is supplied to a first input terminal of a switch circuit 306. The signal delayed_data is supplied to a first input terminal of a switch circuit 307. A value “0” is applied to second input terminals of the switch circuits 306 and 307.

The elementary stream and the enable signal output from the SDTI receiver 108 are supplied to the delay circuit 300 for adjusting the detection delay, and are also supplied to the detector circuits 301, 302, and 303. Each of the detector circuits 301, 302, and 303 may perform pattern matching on the input elementary stream to detect a start code of a predetermined layer.

As described with respect to FIGS. 13A and 13B, in the MPEG elementary stream, the sequence layer, the GOP layer, and the picture layer each have a code boundary partitioned in bytes. As shown in FIGS. 2 to 7, the data length of the start code in each of the sequence layer, the GOP layer, and the picture layer which are partitioned in frames is set 32 bits. Thus, the detector circuits 301, 302, and 303 perform pattern matching for units of byte, making it possible to detect the start codes of the layers.

The detector circuit 301 detects the sequence header code 1, or a start code of the sequence layer. The sequence header code 1 has a byte sequence of [00 00 01 B3]. The detector circuit 301 performs pattern matching for units of one byte, and this byte sequence is detected to detect the sequence header code 1. The result of detection is output as a signal sequence_header_code_det having a value set “1” when the sequence header code 1 is detected and at “0” otherwise. The signal sequence_header_code_det is delivered to a first input terminal of the OR circuit 310.

The detector circuit 302 detects the GOP start code 5, or a start code of the GOP layer. The GOP start code 5 has a byte sequence of [00 00 01 B8]. The detector circuit 302 performs pattern matching for units of one byte, and this byte sequence is detected to detect the GOP start code 5. The result of detection is output as a signal group_start_code_det having a value set “1” when the GOP start code 5 is detected and at “0” otherwise. The signal group_start_code_det is delivered to a second input terminal of the OR circuit 310.

The detector circuit 303 detects the picture start code 8, or a start code of the picture layer. The picture start code 8 has a byte sequence of [00 00 01 00]. The detector circuit 303 performs pattern matching for units of one byte, and this byte sequence is detected to detect the picture start code 8. The result of detection is output as a signal picture_start_code_det having a value set “1” when the picture start code 8 is detected and at “0” otherwise. The signal picture_start_code_det is delivered to a third input terminal of the OR circuit 310.

The OR circuit 310 outputs a signal start_code_det based on the results of detection from the detector circuits 301, 302, and 303. More specifically, the OR circuit 310 outputs the signal start_code_det whose value is set “1” when either start code of the sequence layer, the GOP layer, or the picture layer is detected from the input elementary stream. If any start code of the sequence layer, the GOP layer, or the picture layer is not detected, the signal start_code_det is set “0.” The signal start_code_det output from the OR circuit 310 is supplied to a reset input of the RS_FF circuit 304. The signal start_code_det is also supplied to the timing generator 108.

The RS_FF circuit 304 receives the “Frame End” signal at the set input, as previously described. Therefore, an “inhibit” signal output from the RS_FF circuit 304 goes low if the signal start_code_det output from the OR circuit 310 is set “1” when either start code of the sequence layer, the GOP layer, or the picture layer is, and goes high if the “Frame End” signal (substantially, a signal delayed_frame_end) rises.

The “inhibit” signal output from the RS_FF circuit 304 is supplied to the switch circuits 306 and 307. In each of the switch circuits 306 and 307, the first or second input terminal is selectively switched in response to this “inhibit” signal.

The switch circuit 306 switches to the first input terminal when the “inhibit” signal is at the low level to selectively output the signal delayed_enable output from the delay circuit 300. The switch circuit 306 switches to the second input terminal when the “inhibit” signal is at the high level to output a value of 0. Accordingly, regardless of the enable signal “enable,” the enable signal “enable” (substantially, signal delayed_enable) is set “0” in a period during which the “inhibit” signal is at the high level, namely, in a period from when the “Frame End” signal goes high until the next start code has been detected, indicating that the data during that period is invalid.

Likewise, the switch circuit 307 switches to the first input terminal when the “inhibit” signal is at the low level to selectively output the signal delayed_data which is output with delay from the delay circuit 300. The switch circuit 307 switches to the second input terminal when the “inhibit” signal is at the high level to output a value of 0. Accordingly, regardless of the elementary stream, the elementary stream (substantially, signal delayed_data) which is set “0” is always output in a period during which the “inhibit” signal is at the high level, namely, in a period from when the “Frame End” signal goes high until the next start code has been detected.

The timing generator 308 is reset in response to the frame pulse. Then, the timing generator 308 generates a variety of timing signals based on the signal start_code_det and the signal delayed_frame_end. The generated timing signals are delivered to an address controller in a memory, a variable length decoder, etc. (not shown) for appropriate processing.

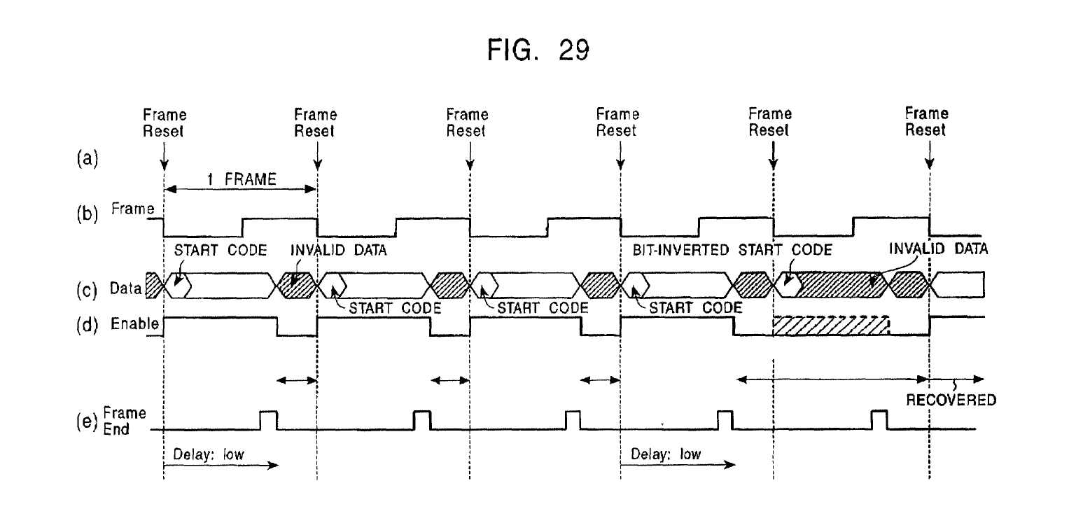

FIG. 29 is a timing chart which illustrates the frame processing according to this embodiment. A frame signal is inverted every ½ frame. A “Frame Reset” signal is used to initialize the processing at the beginning of a frame in response to this frame signal. An elementary stream is transmitted every frame. As described above, data compression is performed using a variable length code in the MPEG algorithm, and the elementary stream is supplied in a burst mode in one frame in SDTI-CP. The data in the remaining period in one frame is invalid.

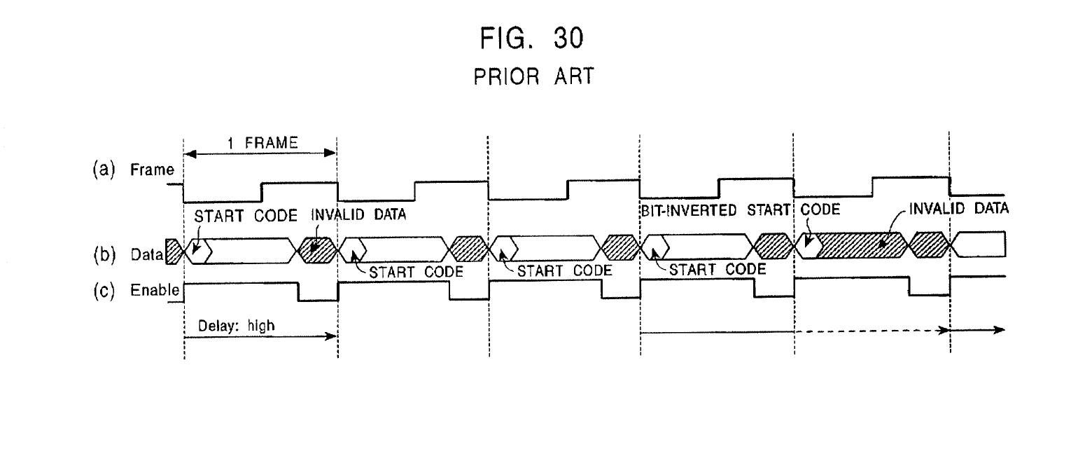

FIG. 29, as in FIG. 30, the start code indicating the beginning of the frame is bit inverted at the fifth frame, so that the start code of the fifth frame is not detected.

As previously described, an enable signal “enable” is generated based on a “Frame End” signal and the result of detection of the start code. As described above, once either start code of a frame, namely, the sequence header code 1, the GOP start code 5, or the picture start code 8, is detected, the enable signal “enable” is output as a value delayed_enable indicating valid data, and is set a value indicating invalid data, such as “0,” in synchronization with the “Frame End” signal regardless of the enable signal delayed_enable.

Therefore, in the first to fourth frames in which either start code is normally detectable, the enable signal “enable” is set a value, such as “0,” indicating invalid data in synchronization with the “Frame End” signal at the point when the data of the frames end. Once a start code is detected at the beginning of the next frame, the enable signal “enable” is output as a value delayed_enable indicating valid data, and is set “1,” by way of example.

In response to the “Frame End” signal which is synchronized with the end-of-frame data, the processing ends in that frame. When the next start code is detected, immediate processing can be performed or the processing is ready for the next frame, thereby reducing the processing delay.

Since the “Frame End” signal which is synchronized with the end position of the data which is transmitted in a burst mode in one frame is used to recognize the end of that frame, and a start code is detected to recognize the beginning of the next frame, the current frame ends in a different timing from beginning of the next frame. This ensures that the processing every frame is reset, as shown in FIG. 29.

For example, if a start code is undetectable at the fifth frame for some reason, the RS_RR circuit 304 is set at the fourth frame in response to the “Frame End” signal, so that the enable signal “enable” is set “0” indicating invalid data. However, since a start code is not detectable at the fifth frame, the RS_FF circuit 304 is not reset at that point. Thus, the enable signal “enable” is always kept value “0” indicating invalid data regardless of the value delayed_enable. When the next start code is detected, the RS_FF circuit 304 is reset so that the enable signal “enable” is output as the value delayed_enable indicating valid data.

In this way, the “Frame End” signal which is synchronized with the end-of-frame data is used to ensure that the processing on that frame is completed. Furthermore, the data after the “Frame End” signal can be ignored, thereby reliably eliminating invalid data.

Although a recording medium for recording MPEG ES is implemented as a magnetic tape in the illustrated embodiments, this is not limited. The present invention may also be embodied as a disk recording medium such as a hard disk drive.

As described above, according to the present embodiment, the “Frame End” signal which is synchronized with the end-of-frame data is used for each frame, allowing immediate processing of the next frame after a start code is detected, thereby reducing the processing delay.

Furthermore, the “Frame End” signal allows the end of a frame to be reliably identified, thereby providing stable processing every frame.

The enable signal “enable” is set a value indicating invalid data in response to the “Frame End” signal, and the enable signal “enable” is set a value indicating valid data once a start code is detected. Therefore, if a start code is not detected, the data is considered to be invalid. The processing can be recovered at the point where the next start code has been detected. This is robust to irregular stream inputs.

According to the illustrated embodiments, therefore, a highly reliable MPEG stream processor or a VTR capable of supporting an MPEG stream can be achieved.

What is claimed is:

1. A signal processor for processing a predetermined unit of input data containing a variable length code and information providing the active length of the variable length code, said signal processor comprising:
input means for inputting the input data;
start detecting means for detecting the start of the predetermined unit of the input data;
end detecting means for detecting the end of the predetermined unit of the input data input by said input means based on the information providing the active length; and
signal processing means for making an action on the variable length code active at the start detected by said start detecting means, for making the action on the variable length code inactive at the end detected by said end detecting means, and for initializing the state of the action on the variable length code at the end detected by said end detecting means.

2. A signal processor according to claim 1, wherein the input data comprises MPEG encoded data.

3. A signal processor according to claim 1, further comprising recording means for recording the output of said signal processing means.

4. A signal processing method for processing a predetermined unit of input data containing a variable length code and information providing the active length of the variable length code, said signal processing method comprising the steps of:
inputting the input data;
detecting the start of the predetermined unit of the input data input in said inputting step;
detecting the end of the predetermined unit of the input data input in said inputting step based on the information providing the active length; and
performing processes to make an action on the variable length code active at the start detected in said start detecting step, to make the action on the variable length code inactive at the end detected in said end detecting step, and to initialize the state of the action on the variable length code at the end detected in said end detecting step.

5. A signal processing method according to claim 4, further comprising the step of recording the result of said process performing step.
